(19) United States
(12) Patent Application Publication
(10) Pub. No.: US 2019/0088420 A1
(43) Pub. Date: Mar. 21, 2019

(54) LASER INDUCED GRAPHENE HYBRID MATERIALS FOR ELECTRONIC DEVICES

(71) Applicants: James M. Tour, Bellaire, TX (US); Lei Li, Houston, TX (US); Zhiwei Peng, Houston, TX (US); Jibo Zhang, Houston, TX (US)

(72) Inventors: James M. Tour, Bellaire, TX (US); Lei Li, Houston, TX (US); Zhiwei Peng, Houston, TX (US); Jibo Zhang, Houston, TX (US)

(73) Assignee: William Marsh Rice University, Houston, TX (US)

(21) Appl. No.: 15/528,320

(22) PCT Filed: Nov. 27, 2015
(86) PCT No.: PCT/US2015/062832

§ 371 Date: May 19, 2017

Related U.S. Application Data
(60) Provisional application No. 62/171,095, filed on Jun. 4, 2015.
(60) Provisional application No. 62/085,125, filed on Nov. 26, 2014.

(51) Int. Cl. H01G 11/36; C01B 32/184; C01B 32/194; H01M 4/587; H01M 4/62

(52) U.S. Cl. CPC H01G 11/36; C01B 32/184; C01B 32/194; C01B 2204/32; H01M 4/625; C01B 2204/04; C01B 2204/22; H01M 4/587

(57) ABSTRACT

In some embodiments, the present disclosure pertains to methods of producing a graphene hybrid material by exposing a graphene precursor material to a laser source to form a laser-induced graphene, where the laser-induced graphene is derived from the graphene precursor material. The methods of the present disclosure also include a step of associating a pseudocapacitive material (e.g., a conducting polymer or a metal oxide) with the laser-induced graphene to form the graphene hybrid material. The formed graphene hybrid material can become embedded with or separated from the graphene precursor material. The graphene hybrid materials can also be utilized as components of an electronic device, such as electrodes in a microsupercapacitor. Additional embodiments of the present disclosure pertain to the aforementioned graphene hybrid materials and electronic devices.

### CROSS-REFERENCE TO RELATED APPLICATIONS

This application claims priority to U.S. Provisional Patent Application No. 62/085125, filed on Nov. 26, 2014; and U.S. Provisional Patent Application No. 62/171,095, filed on Jun. 4, 2015. This application is also related to PCT/US2015/016165, filed on Feb. 17, 2015, which claims priority to U.S. Provisional Patent Application No. 61/940,772, filed on Feb. 17, 2014; and U.S. Provisional Patent Application No. 62/005,350, filed on May 30, 2014. The entirety of each of the aforementioned applications is incorporated herein by reference.

### STATEMENT REGARDING FEDERALLY SPONSORED RESEARCH

This invention was made with government support under Grant No. FA9550-14-1-0111, awarded by the U.S. Department of Defense; and Grant No. FA9550-12-1-0035, awarded by the U.S. Department of Defense. The government has certain rights in the invention.

### BACKGROUND

Current graphene-based electronic materials have numerous limitations in terms of manufacturing efficiency, flexibility, and electrical properties. The present disclosure addresses such limitations.

### SUMMARY

In some embodiments, the present disclosure pertains to methods of producing a graphene hybrid material by exposing a graphene precursor material to a laser source to form a laser-induced graphene, where the laser-induced graphene is derived from the graphene precursor material. The methods of the present disclosure also include a step of associating a pseudocapacitive material with laser-induced graphene to form the graphene hybrid material. Pseudocapacitive material association can occur before, during or after the formation of the laser-induced graphene.

In some embodiments, the graphene precursor material includes a polymer, such as a polyimide film. In some embodiments, the graphene precursor material is chosen such that an absorbance band in the graphene precursor material matches the excitation wavelength of the laser source.

In some embodiments, the laser source is a CO₂ laser source. In some embodiments, the exposure of a surface of a graphene precursor material to a laser source results in the formation of the laser-induced graphene on the surface of the graphene precursor material. In some embodiments, the laser-induced graphene becomes embedded with the graphene precursor material. In some embodiments, the exposing results in the patterning of the surface of the graphene precursor material with the laser-induced graphene to form an interdigitated structure on the surface of the graphene precursor material.

In some embodiments, the exposure of a surface of a graphene precursor material to a laser source results in conversion of the entire graphene precursor material to laser-induced graphene. In some embodiments, the exposing results in the separation of the formed laser-induced graphene from the remaining graphene precursor material. In some embodiments, the methods of the present disclosure also include a step of separating the formed laser-induced graphene from the graphene precursor material.

In some embodiments, the pseudocapacitive material that is associated with the laser-induced graphene includes, without limitation, polymers, conducting polymers, metals, metal oxides, metal chalcogenides, metal salts, metal carbides, transition metals, transition metal oxides, transition metal chalcogenides, transition metal salts, transition metal carbides, heteroatoms, organic additives, inorganic additives, metal organic compounds, and combinations thereof. In some embodiments, the pseudocapacitive material includes a conducting polymer, such as polyaniline. In some embodiments, the pseudocapacitive material includes a metal oxide, such as ferric oxyhydroxide, manganese dioxide, and combinations thereof.

In some embodiments, the formed graphene hybrid material becomes embedded with the graphene precursor material. In some embodiments, the formed graphene hybrid material is separated from the graphene precursor material. In some embodiments, the methods of the present disclosure also include a step of separating the formed graphene hybrid material from the graphene precursor material.

In some embodiments, the methods of the present disclosure also include a step of utilizing the graphene hybrid material as a component of an electronic device. In some embodiments, the graphene hybrid material is utilized as a component of the electronic device while embedded with the graphene precursor material. In some embodiments, the graphene hybrid material is utilized as a component of the electronic device after separation from the graphene precursor material.

In some embodiments, the electronic device is an energy storage device or an energy generation device. In some embodiments, the electronic device is an energy storage device, such as a microsupercapacitor. In some embodiments, the graphene hybrid material is utilized in the electronic device as at least one of electrodes, current collectors, additives, active materials, and combinations thereof. In some embodiments, the graphene hybrid material is utilized as an electrode in the electronic device.

Additional embodiments of the present disclosure pertain to the aforementioned graphene hybrid materials. Further embodiments of the present disclosure pertain to electronic devices that contain the graphene hybrid materials of the present disclosure.

### DESCRIPTION OF THE FIGURES

FIG. 1 provides various schemes and illustrations, including a scheme of a method of forming graphene hybrid materials (FIG. 1A), a photograph of a graphene hybrid material (FIG. 1B), and an illustration of a microsupercapacitor that contains the graphene hybrid material (FIG. 1C).

FIG. 2 provides schemes and illustrations relating to the fabrication and structural morphology of microsupercapacitors (MSCs) that include laser-induced graphene (LIG) coated with manganese dioxide (MnO₂) (LIG-MnO₂-MSC). FIG. 2A shows the scheme of the fabrication of MSCs with LIG-MnO₂, which is similar to the formation of LIG coated with ferric oxyhydroxide (LIG-FeOOH), or LIG coated with polyaniline (LIG-PANI). Numbers 1, 2, 3, and 4 are epoxy adhesive, silver paste, Kapton tape and copper tape, respectively. FIG. 2B is a digital photograph of one MSC device. FIG. 2C is a cross-sectional scanning electron microscopy (SEM) image of LIG-MnO₂ on a polyimide (PI) film. The scale bar is 100 μm. FIGS. 2D-G provide SEM images of top views of LIG (FIGS. 2D-E), and MnO₂ in LIG-MnO₂ (FIGS. 2F-G). The scale bars are 100 μm for FIGS. 2D and F, and 2 μm for FIGS. 2E and G. The lined-pattern in FIGS. 2D and F are due to raster scanning of the laser.

FIG. 3 shows a digital image of LIG on a PI sheet with different sizes.

FIG. 4 shows cross-sectional SEM images of LIG. The scale bars are 100 μm.

FIG. 5 shows cross-sectional SEM images of LIG-MnO₂—X. The scale bars are 100 μm.

FIG. 6 shows cross-sectional SEM images of LIG-PANI-Y. The scale bars are 100 μm.

FIG. 7 shows SEM images of FeOOH in LIG-FeOOH, and PANI in LIG-PANI. The scale bars are 100 μm for FIGS. 7A-B and D-E, and 2 μm for FIGS. 7C and F. The lined-pattern in FIGS. 7B and E are due to the raster scanning of the laser.

FIG. 8 shows transmission electron microscopy (TEM) images of LIG-MnO₂. The scale bar is 400 nm for FIG. 8A, 20 nm for FIGS. 8B-C, and 10 nm for FIG. 8D.

FIG. 9 shows TEM images of LIG-FeOOH. The scale bar is 200 nm for FIG. 9A and 10 nm for FIGS. 9B-C.

FIG. 10 shows TEM images of LIG-PANI. The scale bar is 4 μm for FIG. 10A, 200 nm for FIG. 10B, and 10 nm for FIGS. 10C-D.

FIG. 11 shows Raman spectra of LIG and LIG-PANI-15 (FIG. 11A), x-ray powder diffraction (XRD) patterns of LIG, LIG-PANI-15, LIG-MnO₂-2.5 h, and LIG-FeOOH-1.5 h (FIG. 11B), x-ray photoelectron spectroscopy (XPS) spectra of LIG, LIG-PANI-15, LIG-MnO₂-2.5 h, and LIG-FeOOH-1.5 h (FIG. 11C), elemental XPS spectrum of Mn 2p for LIG-MnO₂-2.5 h (FIG. 11D), and Fe 2p for LIG-FeOOH-1.5 h (FIG. 11E).

FIG. 12 provides data relating to the electrochemical performance of LIG-MnO₂ and LIG-PANI MSCs. FIG. 12A provides cyclic voltammetry (CV) curves of LIG-MnO₂—X and LIG at a scan rate of 5 mV/s. FIG. 12B provides galvanostatic charge discharge curves of LIG-MnO₂-X and LIG at a current density of 0.5 mA/cm². FIG. 12C provides areal specific capacitance of LIG-MnO₂—X and LIG over a current density range of 0.5 and 8.0 mA/cm². FIG. 12D provides CV curves of LIG-PANI-Y and LIG at a scan rate of 10 mV/s. FIG. 12E provides galvanostatic charge discharge curves of LIG-PANI-Y and LIG at a current density of 0.5 mA/cm². FIG. 12F provides areal specific capacitance of LIG-PANI-Y and LIG over a current density range of 0.5 and 20.0 mA/cm². FIG. 12G provides cycling stability of LIG-MnO₂-2.5 h at the current density of 1.0 mA/cm². FIG. 12H provides cycling stability of LIG-PANI-15 at the current density of 0.8 mA/cm².

FIG. 13 shows the CV curves of LIG-MnO₂—X.

FIG. 14 shows the galvanostatic charge discharge curves of LIG-MnO₂—X.

FIG. 15 shows the volumetric specific capacitance of LIG-MnO₂—X.

FIG. 16 shows the dimension of the MSCs with the interdigitated electrodes in plane.

FIG. 17 shows the CV curves of LIG-PANI-Y.

FIG. 18 shows the galvanostatic charge discharge curves of LIG-PANI-Y.

FIG. 19 shows the volumetric specific capacitance of LIG-PANI-Y.

FIG. 20 shows the assembling and characterization of multiple electronic devices in parallel and series configurations.

FIG. 21 shows the CV curves of LIG-FeOOH—X in three-electrode systems.

FIG. 22 shows the galvanostatic charge discharge curves and areal capacitance of LIG-FeOOH—X in a three electrode system.

FIG. 23 shows the cross-sectional SEM images of LIG-MnO₂-0.27 h. The scale bar is 100 μm.

FIG. 24 shows the CV curves of LIG-MnO₂—X in a three electrode system.

FIG. 25 provides data relating to the electrochemical performance of asymmetric MSCs that contain LIG-FeOOH and LIG-MnO₂ as electrodes (LIG-FeOOH//LIG-MnO₂). FIG. 25A provides CV curves of LIG-FeOOH//LIG-MnO₂ at a scan rate range of 10 to 100 mV/s. FIG. 25B provides galvanostatic charge discharge curves of LIG-FeOOH//LIG-MnO₂ at a current density range of 0.25 to 4.0 mA/cm². FIG. 25C provides areal and volumetric specific capacitance of LIG-FeOOH//LIG-MnO₂ over a current density range of 0.25 and 10 mA/cm². FIG. 25D provides cycling stability of LIG-FeOOH//LIG-MnO₂ at the current density of 1.0 mA/cm².

FIG. 26 shows the galvanostatic charge discharge curves and areal capacitance of LIG-MnO₂—X in a three-electrode system.

FIG. 27 shows the digital image of one LED lit by one asymmetric MSC of LIG-FeOOH//LIG-MnO₂.

FIG. 28 shows the galvanostatic charge discharge curves of LIG-FeOOH//LIG-MnO₂.

FIG. 29 provides data relating to the flexibility testing of LIG-MnO₂-2.5 h, LIG-PANI-15, and LIG-FeOOH//LIG-MnO₂. FIG. 29A is a digital photograph of a device under bending. The angle labeled as α_{B} in the image is defined as the bending angle. CV curves and capacitance retention of LIG-MnO₂-2.5 h (FIG. 29B), LIG-PANI-15 (FIG. 29C), and LIG-FeOOH//LIG-MnO₂ (FIG. 29D) under bending angles of 0°, 45°, 90°, 135°, and 180° at a scan rate of 40 mV/s. FIG. 29E provides data relating to the capacitance retention of LIG-MnO₂-2.5 h, LIG-PANI-15, and LIG-FeOOH//LIG-MnO₂ at different bending cycles with a α_{B} of ˜90°.

FIG. 30 provides Ragone plots of LIG-MnO₂-2.5 h, LIG-PANI-15, and LIG-FeOOH//LIG-MnO₂. The volumetric energy and power density of LIG-MnO₂-2.5 h, LIG-PANI-15, and LIG-FeOOH//LIG-MnO₂ are compared with commercially available energy storage devices.

FIG. 31 shows the Ragone plots of LIG-MnO₂—X, LIG-FeOOH//LIG-MnO₂, and LIG-PANI-Y.

FIG. 32 shows comparisons of volumetric energy densities (FIG. 32A) and areal capacitance (FIG. 32B) of LIG-derived MSCs with electrodeposited MnO₂ and polyaniline compared to the devices with no additives, and with born doping, in differing electrolytes as noted.

### DETAILED DESCRIPTION

It is to be understood that both the foregoing general description and the following detailed description are illustrative and explanatory, and are not restrictive of the subject matter, as claimed. In this application, the use of the singular includes the plural, the word “a” or “an” means “at least one”, and the use of “or” means “and/or”, unless specifically stated otherwise. Furthermore, the use of the term “including”, as well as other forms, such as “includes” and “included”, is not limiting. Also, terms such as “element” or “component” encompass both elements or components comprising one unit and elements or components that include more than one unit unless specifically stated otherwise.

The section headings used herein are for organizational purposes and are not to be construed as limiting the subject matter described. All documents, or portions of documents, cited in this application, including, but not limited to, patents, patent applications, articles, books, and treatises, are hereby expressly incorporated herein by reference in their entirety for any purpose. In the event that one or more of the incorporated literature and similar materials defines a term in a manner that contradicts the definition of that term in this application, this application controls.

The development and miniaturization of energy storage devices are facilitating the growth of modern micro-electronic systems. Microbatteries are presently the major power source for miniaturized electronic devices, even though they suffer from sluggish charge/discharge processes and a limited cycle life. Microsupercapacitors (MSCs), on the other hand, have high power density, fast charge/discharge rates, and long service life. With their in-plane interdigitated electrodes, MSCs show a pathway to replace microbatteries. However, developing easily fabricated MSCs with high energy densities, close to or exceeding those in microbatteries, without sacrificing other electrochemical characteristics, is a crucial challenge.

The most common strategy for the fabrication of MSCs is to use photolithography to prepare interdigitated patterns of highly conductive carbon materials to provide the electrochemical double layer capacitance (EDLC). Recently, laser writing technology has also been used to reduce and pattern graphene oxide (GO) as interdigitated electrodes in MSCs. However, the synthesis and post-reaction treatment of GO and the problematic stability of the remaining GO in such devices presents commercialization challenges.

Since the energy density of an electronic device (e.g., MSCs) is determined by its capacitance and working voltage (E=CV²/2), further improvement of its energy storage relies on enhancing either of these parameters. To increase device capacitance, pseudocapacitive materials, such as transition metal oxides and electrically conductive polymers, are loaded onto the electrodes to provide pseudocapacitance from surface redox reactions. However, this fabrication strategy is limited by either high-cost patterning processes or harsh synthetic conditions, slowing deployment in commodity electronic devices. Alternatively, organic electrolytes are used for their higher working voltage, resulting in further improvement in energy storage. However, safety issues, complex fabrication processes and strict conditions for the use of organic electrolytes, has limited their widespread application. An alternative approach is to make asymmetric MSCs without using an organic electrolyte.

Recently, Applicants developed a simple and scalable method to prepare patterned porous graphene on a polyimide (PI) substrate by laser-writing patterns in air. See, e.g., PCT/US2015/016165. The resulting laser induced graphene (LIG) showed applications in miniaturized energy storage devices. However, a need exists for developing products with higher capacitance at lower electrical current densities. Various aspects of the present disclosure address this need.

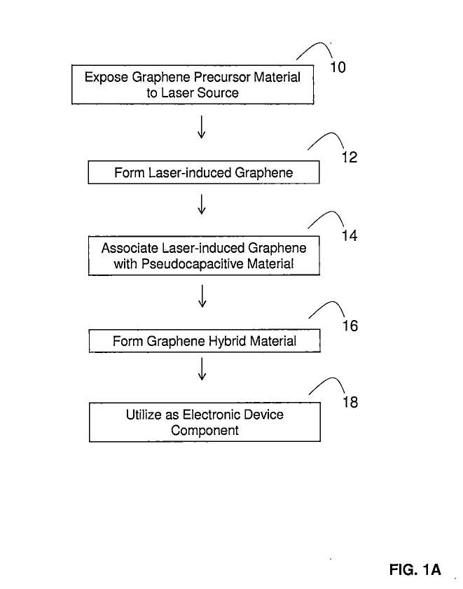

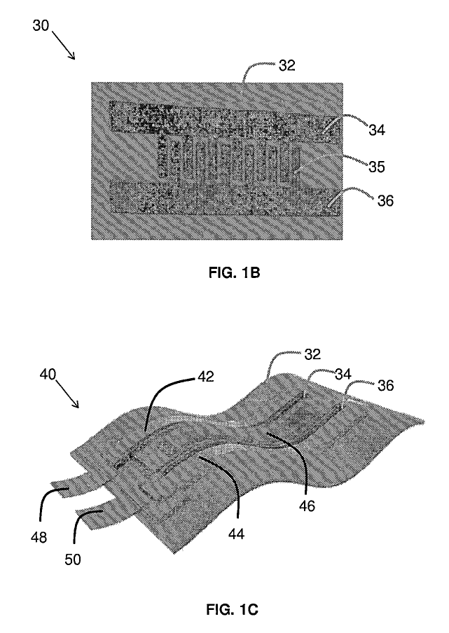

In some embodiments, the present disclosure pertains to methods of producing a graphene hybrid material that includes a laser-induced graphene associated with a pseudocapacitive material. In some embodiments illustrated in FIG. 1A, the methods of the present disclosure include steps of: exposing a graphene precursor material to a laser source (step 10) to form a laser-induced graphene that is derived from the graphene precursor material (step 12), and associating a pseudocapacitive material with the laser-induced graphene (step 14) to form the graphene hybrid material (step 16). In some embodiments, the formed graphene hybrid material may then be utilized as a component of an electronic device (step 18).

Additional embodiments of the present disclosure pertain to the formed graphene hybrid materials. In some embodiments, the graphene hybrid materials are separated from the graphene precursor materials. In some embodiments, the graphene hybrid materials remain associated with the graphene precursor materials. For instance, as illustrated by structure 30 in FIG. 1B, graphene hybrid materials 34 and 36 are embedded with graphene precursor material 32 through an interdigitated architecture 35.

Additional embodiments of the present disclosure pertain to electronic devices that contain the graphene hybrid materials of the present disclosure. For instance, as illustrated in FIG. 1C, structure 30 shown in FIG. 1B may be utilized as a component of microsupercapacitor 40, where graphene hybrid materials 34 and 36 are utilized as electrodes, and where graphene precursor material 32 is utilized as a surface. In this example, graphene hybrid materials 34 and 36 are stabilized by adhesives 42 and 44, respectively. In addition, the graphene hybrid materials are associated with electrolyte 46, tape 48, and tape 50.

As set forth in more detail herein, various methods may be utilized to expose various types of graphene precursor materials to various laser sources to form various types of laser-induced graphenes. Moreover, various methods may be utilized to associate various types of pseudocapacitive materials with laser-induced graphenes to form various types of graphene hybrid materials. Furthermore, the formed graphene hybrid materials may be utilized as components of various electronic devices.

Graphene Precursor Materials

Various graphene precursor materials may be utilized to make laser-induced graphenes. For instance, in some embodiments, the graphene precursor materials include carbon-based materials. In some embodiments, the graphene precursor materials of the present disclosure lack graphite oxides. In some embodiments, the graphene precursor materials of the present disclosure lack graphene oxides. In some embodiments, the graphene precursor materials of the present disclosure include aromatic monomers. In some embodiments, the graphene precursor materials include a polymer. In some embodiments, the polymer includes, without limitation, polymer films, polymer monoliths, polymer powders, polymer blocks, optically transparent polymers, homopolymers, vinyl polymers, block co-polymers, carbonized polymers, aromatic polymers, cyclic polymers, doped polymers, polyimide (PI), polyetherimide (PEI), polyether ether ketone (PEEK), and combinations thereof. In some embodiments, the polymers of the present disclosure include polyimides.

In some embodiments, the graphene precursor materials of the present disclosure may be doped with one or more dopants. In some embodiments, the one or more dopants include, without limitation, molybdenum, tungsten, iron, cobalt, manganese, magnesium, copper, gold, palladium, nickel, platinum, ruthenium, metal chalcogenides, metal halides, metal acetates, metal acetoacetonates, related salts thereof, and combinations thereof.

In some embodiments, the graphene precursor materials of the present disclosure may be doped with one or more metal salts. In some embodiments, the metal salts include, without limitation, iron acetylacetonate, cobalt acetylacetonate, molyddenyl acetylacetonate, nickel acetylacetonate, iron chloride, cobalt chloride, and combinations thereof.

In some embodiments, the doped graphene precursor materials of the present disclosure include heteroatom-doped graphene precursor materials. In some embodiments, the heteroatom-doped graphene precursor materials of the present disclosure include, without limitation, boron-doped graphene precursor materials, nitrogen-doped graphene precursor materials, phosphorus-doped graphene precursor materials, sulfur-doped graphene precursor materials, and combinations thereof. In some embodiments, the heteroatom-doped graphene precursor materials of the present disclosure include boron-doped graphene precursor materials.

The dopants that are associated with the doped graphene precursor materials of the present disclosure can have various shapes. For instance, in some embodiments, the dopants can be in the form of nanostructures. In some embodiments, the nanostructures can include, without limitation, nanoparticles, nanowires, nanotubes, and combinations thereof. Additional dopant structures can also be envisioned.

In some embodiments, the graphene precursor materials of the present disclosure include carbonized graphene precursor materials. In some embodiments, the carbonized graphene precursor materials include glassy or amorphous carbons. In some embodiments, the graphene precursor materials of the present disclosure are carbonized by annealing at high temperatures (e.g., temperatures ranging from about 500° C. to about 2,000° C.).

In some embodiments, the graphene precursor materials of the present disclosure include chemically treated graphene precursor materials. For instance, in some embodiments, the graphene precursor materials of the present disclosure are chemically treated in order to enhance their surface areas. In some embodiments, the graphene precursor materials of the present disclosure are thermally treated with a base, such as potassium hydroxide.

The graphene precursor materials of the present disclosure may be in various forms. For instance, in some embodiments, the graphene precursor materials of the present disclosure may be in the form of at least one of sheets, films, thin films, pellets, powders, coupons, blocks, monolithic blocks, composites, fabricated parts, electronic circuit substrates, flexible substrates, rigid substrates, and combinations thereof. In some embodiments, the graphene precursor materials of the present disclosure are in the form of films, such as polyimide films. In some embodiments, the graphene precursor materials of the present disclosure are in the form of composites, such as polymer composites. In some embodiments, the graphene precursor materials of the present disclosure are in the form of a fabricated part, such an an aircraft wing.

In some embodiments, the graphene precursor materials of the present disclosure are in the form of squares, circles, rectangles, triangles, trapezoids, spheres, pellets, and other similar shapes. In some embodiments, the graphene precursor materials of the present disclosure are in the form of rectangles.

The graphene precursor materials of the present disclosure can have various sizes. For instance, in some embodiments, the graphene precursor materials of the present disclosure have lengths or widths that range from about 100 m to about 1 mm. In some embodiments, the graphene precursor materials of the present disclosure have lengths or widths that range from about 100 cm to about 10 mm. In some embodiments, the graphene precursor materials of the present disclosure have lengths or widths that range from about 10 cm to about 1 cm. In some embodiments, the graphene precursor materials of the present disclosure are in the form of rolls of films that are 100 m long and 1 m wide.

The graphene precursor materials of the present disclosure can also have various thicknesses. For instance, in some embodiments, the graphene precursor materials of the present disclosure have thicknesses that range from about 10 cm to about 1 μm. In some embodiments, the graphene precursor materials of the present disclosure have thicknesses that range from about 1 cm to about 1 mm. In some embodiments, the graphene precursor materials of the present disclosure have thicknesses that range from about 0.3 nm to about 1 cm. In some embodiments, the graphene precursor materials of the present disclosure have thicknesses that range from about 10 mm to about 1 mm.

The graphene precursor materials of the present disclosure can also have various properties. For instance, in some embodiments, the graphene precursor materials of the present disclosure are optically transparent. In some embodiments, the graphene precursor materials of the present disclosure are rigid. In some embodiments, the graphene precursor materials of the present disclosure are flexible. In some embodiments, the graphene precursor materials of the present disclosure are thermally stable (e.g., thermally stable at temperatures over 500° C.).

The use of additional graphene precursor materials can also be envisioned. In some embodiments, the graphene precursor materials of the present disclosure may be chosen based on the chosen laser source. For instance, in some embodiments, the graphene precursor materials of the present disclosure are chosen such that an absorbance band in the graphene precursor material matches the excitation wavelength of a laser source that is utilized to form laser-induced graphenes.

Laser Sources

Various laser sources may be utilized to form laser-induced graphenes from graphene precursor materials. For instance, in some embodiments, the laser source includes, without limitation, a solid state laser source, a gas phase laser source, an infrared laser source, a CO₂ laser source, a UV laser source, a visible laser source, a fiber laser source, and combinations thereof. In some embodiments, the laser source is a UV laser source. In some embodiments, the laser source includes a CO₂ laser source. In some embodiments, the laser source is a CO₂ laser source. Additional laser sources can also be envisioned.

The laser sources of the present disclosure may be utilized at various wavelengths. For instance, in some embodiments, the laser source is utilized at wavelengths ranging from about 1 nm to about 100 μm. In some embodiments, the laser source is utilized at wavelengths ranging from about 20 nm to about 100 μm. In some embodiments, the laser source is utilized at wavelengths ranging from about 1 μm to about 100 μm. In some embodiments, the laser source is utilized at wavelengths ranging from about 1 μm to about 50 μm. In some embodiments, the laser source is utilized at wavelengths ranging from about 1 μm to about 20 μm. In some embodiments, the laser source is utilized at wavelengths ranging from about 5 μm to about 15 μm. In some embodiments, the laser source has a wavelength of about 10 μm. In some embodiments, the laser source is utilized at wavelengths ranging from about 10 nm to about 400 nm. In some embodiments, the laser source is utilized at wavelengths ranging from about 400 nm to about 800 nm.

The laser sources of the present disclosure may be operated at various power ranges. For instance, in some embodiments, the laser sources of the present disclosure are operated at powers that range from about 1 W to about 1000 W. In some embodiments, the laser sources of the present disclosure are operated at powers that range from about 1 W to about 100 W. In some embodiments, the laser sources of the present disclosure are operated at powers that range from about 1 W to about 10 W. In some embodiments, the laser sources of the present disclosure are operated at powers that range from about 1 W to about 6 W. In some embodiments, the laser sources of the present disclosure are operated at powers that range from about 2 W to about 6 W. In some embodiments, the laser sources of the present disclosure are operated at powers that range from about 2 W to about 5 W. In some embodiments, the laser sources of the present disclosure are operated at powers that range from about 2 W to about 4 W. In some embodiments, the laser sources of the present disclosure are operated at powers that range from about 2 W to about 3 W.

The use of additional power ranges for laser sources can also be envisioned. For instance, in some embodiments, the laser sources of the present disclosure have power ranges that can vary based upon the absorbance of the graphene precursor material at a chosen laser wavelength.

The laser sources of the present disclosure can also have various pulse widths. For instance, in some embodiments, the laser sources of the present disclosure have pulse widths that are in the range of femtoseconds, nanoseconds, or milliseconds. In some embodiments, the laser sources of the present disclosure have pulse widths that range from about 1 femtosecond to about 1 ms. In some embodiments, the laser sources of the present disclosure have pulse widths that range from about 1 femtosecond to about 1 ns. In some embodiments, the laser sources of the present disclosure have pulse widths that range from about 1 μs to about 1 ms. In some embodiments, the laser sources of the present disclosure have pulse widths that range from about 1 μs to about 100 μs. In some embodiments, the laser sources of the present disclosure have pulse widths that range from about 10 μs to about 50 μs. In some embodiments, the laser sources of the present disclosure have pulse widths of about 15 μs. Additional pulse widths can also be envisioned.

Exposure of Graphene Precursor Materials to Laser Sources

Various methods may be utilized to expose graphene precursor materials to a laser source. In some embodiments, the exposure occurs manually. In some embodiments, the exposure occurs automatically. For instance, in some embodiments, the exposure occurs automatically through computer-controlled mechanisms. In some embodiments, the exposure occurs automatically through a computer patterning system. In some embodiments, the exposure occurs automatically through automated processing lines. In some embodiments, the exposure occurs automatically through automated processing lines with multiple laser sources. In some embodiments, the multiple laser sources could vary in wavelength or power to cause different degrees of graphene formation over different regions of the graphene precursor material.

In some embodiments, the exposure of graphene precursor materials to a laser source includes pulsed laser irradiation. In some embodiments, the exposure of graphene precursor materials to a laser source includes continuous laser irradiation. In some embodiments, the exposure of graphene precursor materials to a laser source includes patterning a surface of the graphene precursor material with the formed graphene. For instance, in some embodiments, the surface of the graphene precursor material is patterned into interdigitated shapes.

In some embodiments, the exposure of a graphene precursor material to a laser source includes a step of tuning one or more parameters of the laser source. In some embodiments, the one or more tunable parameters of the laser source include, without limitation, laser wavelength, laser power, laser energy density, laser pulse widths, gas environment, gas pressure, gas flow rate, and combinations thereof.

In some embodiments, the wavelength of a laser source is tuned to optimize the formation of laser-induced graphenes from graphene precursor materials. For instance, in some embodiments, a wavelength of a laser source is tuned to match an absorbance band of the graphene precursor material. In such embodiments, a more efficient energy transfer from the laser source to the graphene precursor material can occur, thereby resulting in conversion of the graphene precursor material to graphene in the laser-exposed regions.

In some embodiments, the one or more parameters of a laser source are tuned according to one or more attributes of the exposed graphene precursor material. In some embodiments, the one or more attributes of the exposed graphene precursor material include, without limitation, graphene precursor material type, graphene precursor material thickness, graphene precursor material morphology, graphene precursor material structure, graphene precursor material absorbance spectrum, a substrate upon which a graphene precursor material may be affixed, and combinations thereof.

In some embodiments, a graphene precursor material's absorbance band can be tuned to match the excitation wavelength of a laser source. In some embodiments, the tuning occurs by modifying the structure of the graphene precursor material. In some embodiments, the modification can ensure optimal graphene formation upon laser-graphene precursor material interaction. In some embodiments, the absorbance band of a graphene precursor material can be modified to match the excitation wavelength of the laser source by adding a compound to the graphene precursor material that absorbs well at the excitation wavelength of the laser source.

In some embodiments, the one or more parameters of a laser source are tuned in order to control the penetration depth of the laser wavelength by the graphene precursor material. In some embodiments, the penetration depth (or absorption depth) of a laser source is maximized by tuning the wavelength of the laser source. As such, in some embodiments, a strongly absorbed wavelength can be focused on a graphene precursor material surface to create a desired form of graphene.

Moreover, the availability to choose from many wavelengths can allow for selection of a wide range of penetration depths into a graphene precursor material or type of graphene precursor material by changing the wavelength of the laser source. This in turn allows for controlling the depth of the formed graphene and the type of graphene precursor material from which graphene can be formed. For instance, in some embodiments, the laser source can be tuned to create a narrow and shallow line of graphene on a surface of a graphene precursor material by using a well-focused laser at lower power ranges.

In some embodiments, the exposure of a graphene precursor material to a laser source can include the utilization of optical microscopic techniques. In some embodiments, the microscopic techniques can be used to provide nanometer-scaled patterns of graphene on the graphene precursor material surface. For instance, in some embodiments, near-field scanning optical microscopy (NSOM) can be used during the exposure of a surface of a graphene precursor material to a laser source to provide nanometer-scaled patterns of graphene on the graphene precursor material surface. In some embodiments, the nanometer-scaled patterns of graphene on the graphene precursor material surface can have resolutions of about 20 nm.

The graphene precursor materials of the present disclosure may be exposed to laser sources under various environmental conditions. For instance, in some embodiments, the graphene precursor materials of the present disclosure are exposed to a laser source in the presence of an inert gas, such as argon. In some embodiments, the graphene precursor materials of the present disclosure are exposed to a laser source in the presence of an inert gas and hydrogen (e.g., 10% H₂ in Ar).

In some embodiments, the graphene precursor materials of the present disclosure may be exposed to a single laser source. In some embodiments, the graphene precursor materials of the present disclosure may be exposed to two or more laser sources. In some embodiments, the graphene precursor materials of the present disclosure may be simultaneously exposed to two or more laser sources. In some embodiments, the two or more laser sources may have the same or different wavelengths, power ranges, and pulse widths.

Formation of Laser-Induced Graphenes

The exposure of graphene precursor materials to a laser source can result in the formation of various arrangements of laser-induced graphenes. For instance, in some embodiments, the laser-induced graphene becomes embedded with the graphene precursor material. In some embodiments, a single surface of a graphene precursor material may be exposed to a laser source to form one or more laser-induced graphenes on the surface. In some embodiments, multiple surfaces of a graphene precursor material may be exposed to a laser source to form multiple laser-induced graphenes on different surfaces. In some embodiments, the surfaces may be on opposite sides of the graphene precursor material. In some embodiments, the surfaces may be on the same side of the graphene precursor material.

In some embodiments, the exposure of a graphene precursor material to a laser source results in the patterning of the surface of the graphene precursor material with laser-induced graphenes. For instance, in some embodiments, the laser-induced graphene pattern may be in the form of an interdigitated structure on the surface of the graphene precursor material (e.g., interdigitated structure 35 on graphene precursor material 32, as shown in FIG. 1B).

In some embodiments, the laser-induced graphene forms in a three-dimensional pattern from a graphene precursor material. As such, in some embodiments, the methods of the present disclosure can be utilized for the three-dimensional printing of laser-induced graphene.

In some embodiments, the exposure of the graphene precursor material to a laser source results in the conversion of the entire graphene precursor material to laser-induced graphene (e.g., embodiments where the graphene precursor material is in powder form). In some embodiments, the formed laser-induced graphene consists essentially of laser-induced graphene derived from the graphene precursor material.

In some embodiments, the exposure of the graphene precursor material to a laser source results in the separation of the formed laser-induced graphene from the remaining graphene precursor material. In some embodiments, the laser-induced graphene is manually separated from the graphene precursor material. As such, in some embodiments, the methods of the present disclosure also include a step of separating the laser-induced graphene from the graphene precursor material.

Various methods may be utilized to separate formed laser-induced graphenes from graphene precursor materials. In some embodiments, separating occurs chemically, such as by dissolving the graphene precursor material. In some embodiments, separating occurs mechanically, such as by mechanically stripping the laser-induced graphene from the graphene precursor material. In some embodiments, separating occurs by scraping the laser-induced graphene from a surface of a graphene precursor material. Additional methods by which to separate laser-induced graphenes from graphene precursor materials can also be envisioned.

Without being bound by theory, it is envisioned that laser-induced graphene can form from graphene precursor materials by various mechanisms. For instance, in some embodiments, laser-induced graphene forms by conversion of sp³-carbon atoms of graphene precursor materials to sp²-carbon atoms. In some embodiments, laser-induced graphene forms by photothermal conversion. In some embodiments, laser-induced graphene is formed by photochemical conversion. In some embodiments, laser-induced graphene is formed by both photochemical and photothermal conversion. In some embodiments, laser-induced graphene forms by extrusion of one or more elements. In some embodiments, the one or more elements can include, without limitation, hydrogen, oxygen, nitrogen, sulfur, and combinations thereof.

Laser-Induced Graphenes

The exposure of graphene precursor materials to a laser source can result in the formation of various types of laser-induced graphenes. For instance, in some embodiments, the laser-induced graphene includes, without limitation, single-layered graphene, multi-layered graphene, double-layered graphene, triple-layered graphene, doped graphene, porous graphene, unfunctionalized graphene, pristine graphene, functionalized graphene, oxidized graphene, turbostratic graphene, graphene coated with metal nanoparticles, graphene metal carbides, graphene metal oxides, graphene films, graphene powders, porous graphene powders, porous graphene films, graphite, and combinations thereof.

In some embodiments, the laser-induced graphene includes doped graphene. In some embodiments, the laser-induced graphene includes boron-doped graphene.

In some embodiments, the laser-induced graphene includes functionalized graphene that has been functionalized with one or more functional groups. In some embodiments, the functional groups include, without limitation, oxygen groups, hydroxyl groups, esters, carboxyl groups, ketones, amine groups, nitrogen groups, and combinations thereof.

In some embodiments, the laser-induced graphene includes porous graphene. In some embodiments, the porous graphene includes, without limitation, porous graphene powders, porous graphene thin films, and combinations thereof.

In some embodiments, the porous graphenes include mesoporous graphenes, microporous graphenes, and combinations thereof. In some embodiments, the pores in the porous graphenes include diameters between about 1 nanometer to about 5 micrometers. In some embodiments, the pores include mesopores with diameters of less than about 50 nm. In some embodiments, the pores include mesopores with diameters of less than about 9 nm. In some embodiments, the pores include mesopores with diameters between about 1 μm and about 500 μm. In some embodiments, the pores include mesopores with diameters between about 5 nm and about 10 nm. In some embodiments, the pores include mesopores with diameters between about 1 μm and about 500 μm. In some embodiments, the pores include micropores with diameters of less than about 2 nm. In some embodiments, the pores include micropores with diameters that range from about 1 nm to about 1 μm. Additional pore diameters can also be envisioned.

The formed laser-induced graphenes can have various surface areas. For instance, in some embodiments, the formed laser-induced graphenes have a surface area ranging from about 100 m²/g to about 3,000 m²/g. In some embodiments, the formed laser-induced graphenes have a surface area ranging from about 500 m²/g to about 2,800 m²/g. In some embodiments, the formed laser-induced graphenes have a surface area ranging from about 250 m²/g to about 2,500 m²/g. In some embodiments, the formed laser-induced graphenes have a surface area ranging from about 100 m²/g to about 400 m²/g. In some embodiments, the formed laser-induced graphenes have a surface area ranging from about 150 m²/g to about 350 m²/g.

The formed laser-induced graphenes can also have various thicknesses. For instance, in some embodiments, the formed laser-induced graphenes have a thickness ranging from about 0.3 nm to about 1 cm. In some embodiments, the formed laser-induced graphenes have a thickness ranging from about 0.3 nm to about 100 μm. In some embodiments, the formed laser-induced graphenes have a thickness ranging from about 0.3 nm to about 50 μm. In some embodiments, the formed laser-induced graphenes have a thickness of about 25 μm.

The formed laser-induced graphenes of the present disclosure can also have various shapes. For instance, in some embodiments, the laser-induced graphenes of the present disclosure are in the form of flakes. In some embodiments, the laser-induced graphenes of the present disclosure are highly wrinkled. In some embodiments, the laser-induced graphenes of the present disclosure have ripple-like wrinkled structures. In some embodiments, the laser-induced graphenes have amorphous structures. In some embodiments, the laser-induced graphene include graphitic edges.

In some embodiments, the laser-induced graphenes of the present disclosure have a three-dimensional network. For instance, in some embodiments, the laser-induced graphenes of the present disclosure are in the shape of a foam with porous structures.

In some embodiments, the laser-induced graphenes of the present disclosure have an ordered porous morphology. In some embodiments, the laser-induced graphenes of the present disclosure are in polycrystalline form. In some embodiments, the laser-induced graphenes of the present disclosure are in ultra-polycrystalline form.

In some embodiments, the laser-induced graphenes of the present disclosure contain grain boundaries. In some embodiments, the laser-induced graphenes of the present disclosure include a polycrystalline lattice. In some embodiments, the polycrystalline lattice may include ring structures. In some embodiments, the ring structures include, without limitation, hexagons, heptagons, pentagons, and combinations thereof. In some embodiments, the laser-induced graphenes of the present disclosure have a hexagonal crystal structure. In some embodiments, the laser-induced graphenes of the present disclosure have heptagon-pentagon pairs that include 20% to 80% of the surface structure.

The formed laser-induced graphenes can also have various attributes. For instance, in some embodiments, the formed laser-induced graphenes are thermally stable. In some embodiments, the formed laser-induced graphenes are stable at temperatures up to 2,000° C.

Pseudocapacitive Materials

In some embodiments, pseudocapacitive materials generally refer to materials that store electricity. In some embodiments, pseudocapacitive materials store electricity through very fast reversible faradic redox, electrosorption, and/or intercalation processes on their surfaces. In some embodiments, pseudocapacitive materials enhance the electrical properties of the laser induced graphenes of the present disclosure (e.g., capacitance). In some embodiments, the pseudocapacitive materials of the present disclosure aid in the retention of charge. As such, in some embodiments, the pseudocapacitive materials of the present disclosure can substantially increase the amount of charge retention, thereby making the electronic capacity of electronic devices that contain the graphene hybrid materials of the present disclosure (e.g., electroactive devices) far higher than if prepared without the presence of pseudocapacitive materials.

The laser-induced graphenes of the present disclosure may be associated with various pseudocapacitive materials. In some embodiments, the pseudocapacitive materials of the present disclosure include, without limitation, polymers, conducting polymers, metals, metal oxides, metal chalcogenides, metal salts, metal carbides, transition metals, transition metal oxides, transition metal chalcogenides, transition metal salts, transition metal carbides, heteroatoms, organic additives, inorganic additives, metal organic compounds, and combinations thereof.

In some embodiments, the pseudocapacitive materials include a conducting polymer. In some embodiments, the conducting polymer includes, without limitation, polyaniline, polythiophene, polypyrrole, polyacetylene, and combinations thereof. In some embodiments, the conducting polymer includes polyaniline.

In some embodiments, the pseudocapacitive materials include a metal oxide. In some embodiments, the metal oxide includes, without limitation, iron oxide, magnesium oxide, copper oxide, cobalt oxide, nickel oxide, ruthenium oxide, magnetite, ferric oxyhydroxide, manganese dioxide, titanium oxide, vanadium oxide, platinum oxide, palladium oxide, and combinations thereof. In some embodiments, the metal oxide includes ferric oxyhydroxide (FeOOH). In some embodiments, the metal oxide includes manganese dioxide (MnO₂).

Association of Laser-Induced Graphene with Pseudocapacitive Materials

The association of a laser-induced graphene with a pseudocapacitive material can occur at various times. For instance, in some embodiments, the association occurs before the formation of the laser-induced graphene. In such embodiments, pseudocapacitive materials may be associated with graphene precursor materials prior to their exposure to a laser source.

In some embodiments, the association of a laser-induced graphene with a pseudocapacitive material occurs during the formation of the laser-induced graphene. In such embodiments, pseudocapacitive materials may be associated with graphene precursor materials during their exposure to a laser source.

In some embodiments, the association of a laser-induced graphene with a pseudocapacitive material occurs after the formation of the laser-induced graphene. In such embodiments, pseudocapacitive materials may be associated with graphene precursor materials after their exposure to a laser source.

In some embodiments, the association of a laser-induced graphene with a pseudocapacitive material occurs at more than one time during laser-induced graphene formation. For instance, in some embodiments, the association of a laser-induced graphene with a pseudocapacitive material occurs before, during and after the formation of the laser-induced graphene.

In some embodiments, the association of a laser-induced graphene with a pseudocapacitive material occurs while the laser-induced graphene is embedded with the graphene precursor material. In some embodiments, the association of a laser-induced graphene with a pseudocapacitive material occurs after the laser-induced graphene is separated from the graphene precursor material. In some embodiments, the separation of a laser-induced graphene from the graphene precursor material occurs after its association with a pseudocapacitive material.

Various methods may be utilized to associate laser-induced graphenes with pseudocapacitive materials. For instance, in some embodiments, the association occurs by a method that includes, without limitation, electrochemical deposition, coating, spin coating, spraying, spray coating, patterning, thermal activation, and combinations thereof. In some embodiments, the association occurs by coating.

In some embodiments, laser-induced graphenes become associated with pseudocapacitive materials by electrochemical deposition. In some embodiments, electrochemical deposition occurs by cyclic voltammetry. In some embodiments, the electrochemical deposition occurs by a method that includes, without limitation, cyclic voltammetry, linear sweep voltammetry, chronopotentiometry, chronoamperometry, chronocoulometry, and combinations thereof. In some embodiments, the electrochemical deposition occurs at current densities that range from about 0.05 mA/cm² to about 200 mA/cm². .In some embodiments, the electrochemical deposition occurs at current densities that range from about 0.5 mA/cm² to about 200 mA/cm². In some embodiments, the electrochemical deposition occurs at current densities that range from about 0.5 mA/cm² to about 100 mA/cm². In some embodiments, the electrochemical deposition occurs at an adjustable current density.

In some embodiments, laser-induced graphenes become associated with pseudocapacitive materials by thermal activation. In some embodiments, the thermal activation includes chemical treatment through the use of various bases, such as potassium hydroxide (KOH).

Laser-induced graphenes can become associated with pseudocapacitive materials at various scan rates. For instance, in some embodiments, the scan rate is adjustable from about 1 mV/s to about 1000 mV/s.

Laser-induced graphenes can also become associated with pseudocapacitive materials through multiple association cycles. In some embodiments, the number of association cycles can determine the amount of deposited pseudocapacitive material. In some embodiments, the number of association cycles can range from about 1 cycle to about 100 cycles. In some embodiments, the number of association cycles can range from about 1 cycle to about 50 cycles.

Laser-induced graphenes can also become associated with pseudocapacitive materials for different amounts of time. In some embodiments, the association time can determine the amount of deposited pseudocapacitive material. In some embodiments, the association time ranges from about 1 second to about 12 hours. In some embodiments, the association time ranges from about 1 minute to about 500 minutes. In some embodiments, the association time ranges from about 5 minutes to about 240 minutes.

Laser-induced graphenes can become associated with pseudocapacitive materials in various manners. For instance, in some embodiments, the association occurs on a single side of a laser-induced graphene. In some embodiments, the association occurs on opposite sides of the laser-induced graphene. In some embodiments, the association occurs in a symmetric manner. In some embodiments, the association occurs in an asymmetric manner. In some embodiments, the association results in a partial coverage of laser-induced graphenes with pseudocapacitive materials. In some embodiments, the association results in a complete coverage of laser-induced graphenes with pseudocapacitive materials.

Laser-induced graphenes can become associated with pseudocapacitive materials through various processes. For instance, in some embodiments, the association of pseudocapacitive materials with laser-induced graphenes occur manually. In some embodiments, the association occurs automatically, such as through the use of computer-controlled systems.

Reaction Conditions

The methods of the present disclosure can occur under various reaction conditions. For instance, in some embodiments, the methods of the present disclosure occur under ambient conditions. In some embodiments, the ambient conditions include, without limitation, room temperature, ambient pressure, presence of air, and combinations thereof. In some embodiments, the ambient conditions include room temperature, ambient pressure, and presence of air.

Moreover, as set forth previously, one or more steps of the methods of the present disclosure can occur manually. Likewise, one or more steps of the methods of the present disclosure can occur automatically, such as through the use of computer-controlled automatic processing lines.

In some embodiments, one or more steps of the present disclosure can occur in the presence of one or more gases. In some embodiments, the one or more gases include, without limitation, hydrogen, ammonia, argon nitrogen, oxygen, carbon dioxide, methane, ethane, ethene, chlorine, fluorine, acetylene, natural gas, and combinations thereof.

In some embodiments, one or more steps of the present disclosure can occur in an environment that includes ambient air. In some embodiments, the environment includes, without limitation, hydrogen, argon, methane, and combinations thereof. Additional reaction conditions can also be envisioned.

Graphene Hybrid Materials

The methods of the present disclosure can result in the formation of various types of graphene hybrid materials. Additional embodiments of the present disclosure pertain to the formed graphene hybrid materials.

In some embodiments, the graphene hybrid materials of the present disclosure are separated from the graphene precursor material. In some embodiments, the methods of the present disclosure also include a step of separating the formed graphene hybrid material from the graphene precursor material to form isolated graphene hybrid materials (suitable separation methods were described previously). As such, in some embodiments, the present disclosure pertains to isolated graphene derived from a graphene precursor material, where the graphene is separated from the graphene precursor material, and where the graphene is associated with a pseudocapacitive material.

In some embodiments, the graphene hybrid materials of the present disclosure are associated with the graphene precursor material. As such, in some embodiments (e.g., embodiments illustrated in FIG. 1B), the graphene hybrid materials of the present disclosure include a graphene precursor material (e.g., 32 in FIG. 1B); and a laser-induced graphene derived from the graphene precursor material (e.g., 34 and 36 in FIG. 1B), where the graphene is on a surface of the graphene precursor material, and where the graphene is associated with a pseudocapacitive material. In some embodiments, the laser-induced graphenes are patterned on a surface of the graphene precursor material to form a pattern, such as an interdigitated architecture (e.g., 35 in FIG. 1B). In some embodiments, the graphene hybrid material is embedded with the graphene precursor material.

The graphene hybrid materials of the present disclosure can have various types of graphenes and pseudocapacitive materials. Suitable graphenes and pseudocapacitive materials were described previously. Moreover, the graphene hybrid materials of the present disclosure can have various thicknesses. For instance, in some embodiments, the graphene hybrid materials of the present disclosure have a thickness ranging from about 1 μm to about 500 μm. In some embodiments, the graphene hybrid materials of the present disclosure have a thickness ranging from about 10 μm to about 200 μm. In some embodiments, the graphene hybrid materials of the present disclosure have a thickness ranging from about 30 μm to about 100 μm. In some embodiments, the graphene hybrid materials of the present disclosure have a thickness ranging from about 40 μm to about 100 μm. In some embodiments, the graphene hybrid materials of the present disclosure have a thickness ranging from about 60 μm to about 100 μm.

Electronic Devices

The graphene hybrid materials of the present disclosure can be utilized as components of various electronic devices. As such, in some embodiments, the methods of the present disclosure also include a step of utilizing the graphene hybrid materials of the present disclosure as a component of an electronic device. In some embodiments, the methods of the present disclosure include a step of incorporating the graphene hybrid materials of the present disclosure into an electronic device.

Additional embodiments of the present disclosure pertain to electronic devices that include the graphene hybrid materials of the present disclosure. In some embodiments, the graphene hybrid materials of the present disclosure are utilized as a component of an electronic device while embedded with the graphene precursor material. In some embodiments, the graphene hybrid materials of the present disclosure are utilized as a component of an electronic device after separation from the graphene precursor material.

The graphene hybrid materials of the present disclosure may be incorporated into various electronic devices. For instance, in some embodiments, the electronic device is an energy storage device or an energy generation device. In some embodiments, the electronic device is an energy storage device. In some embodiments, the electronic device includes, without limitation, capacitors, supercapacitors, microsupercapacitors, pseudocapacitors, batteries, microbatteries, lithium-ion batteries, sodium-ion batteries, magnesium-ion batteries, electrodes, conductive electrodes, sensors, photovoltaic devices, electronic circuits, fuel cell devices, thermal management devices, biomedical devices, transistors, water splitting devices, and combinations thereof.

In some embodiments, the electronic device is a supercapacitor. In some embodiments, the electronic device is a microsupercapacitor (e.g., microsupercapacitor 40 shown in FIG. 1C).

The graphene hybrid materials of the present disclosure can be utilized as various electronic device components. For instance, in some embodiments, the graphene hybrid materials of the present disclosure are utilized as at least one of electrodes, current collectors, additives, active materials, and combinations thereof. In some embodiments, the graphene hybrid materials of the present disclosure are utilized as both active materials and current collectors in an electronic device.

In some embodiments, the graphene hybrid materials of the present disclosure are utilized as an electrode in an electronic device. In some embodiments, the electrode includes, without limitation, positive electrodes, negative electrodes, electrochemical double layer capacitance (EDLC) electrodes, and combinations thereof. In some embodiments, the graphene hybrid materials of the present disclosure are utilized as a positive electrode in an electronic device. In some embodiments, the graphene hybrid materials of the present disclosure are utilized as a negative electrode in an electronic device. In some embodiments, the graphene hybrid materials of the present disclosure are utilized as a positive electrode and a negative electrode in an electronic device. In some embodiments, a graphene hybrid material with a first pseudocapacitive material (e.g., MnO₂) serves as a positive electrode while a graphene hybrid material with a different pseudocapacitive material (e.g., FeOOH) serves as a negative electrode. In some embodiments, the electrodes are free of current collectors, binders, and separators. In some embodiments, the graphene hybrid materials of the present disclosure are utilized as electrodes in a microsupercapacitor (e.g., microsupercapacitor 40 in FIG. 1C).

The electronic devices of the present disclosure can have various structures. For instance, in some embodiments, the electronic devices of the present disclosure include, without limitation, vertically stacked electronic devices, in-plane electronic devices, symmetric electronic devices, asymmetric electronic devices, electronic devices in parallel configurations, electronic devices in series configurations, all-solid-state electronic devices, flexible electronic devices, and combinations thereof.

In some embodiments, the electronic devices of the present disclosure include stacked electronic devices, such as vertically stacked electronic devices. In some embodiments, a plurality of graphene hybrid materials are stacked to result in the formation of a vertically stacked electronic device.

The electronic devices of the present disclosure may also be associated with various electrolytes. As such, in some embodiments, the methods of the present disclosure can also include a step of associating the electronic devices of the present disclosure with an electrolyte.

In some embodiments, the electrolytes include, without limitation, aqueous electrolytes, liquid electrolytes, solid state electrolytes, organic salt electrolytes, ionic liquid electrolytes, solid state electrolytes made from inorganic compounds, solid state polymer electrolytes made from liquid electrolytes, and combinations thereof. In some embodiments, the electrolytes include solid state electrolytes. In some embodiments, the electrolyte is a liquid electrolyte, where the liquid electrolyte can be made into solid state polymer electrolyte.

The electronic devices of the present disclosure can also include additional components. Such additional components can include, without limitation, wires (e.g., wires made from conductive metals, such as copper, iron, stainless steel, tin, aluminum, and combinations thereof), conductive pastes (e.g., silver pastes, gold pastes, graphene pastes, graphene nanoribbon pastes, carbon pastes, and combinations thereof) that connect the electronic device components (e.g., wires and electrodes), working devices that are connected to the electronic devices (e.g., through the wires), and combinations thereof. In some embodiments, the working devices include voltage and current sources.

Electronic Device Properties

The electronic devices of the present disclosure can have various advantageous properties. For instance, in some embodiments, the electronic devices of the present disclosure have an areal capacitance ranging from about 100 mF/cm² to about 10 F/cm² at a current density of 0.5 mA/cm². In some embodiments, the electronic devices of the present disclosure have an areal capacitance ranging from about 100 mF/cm² to about 2000 mF/cm² at a current density of 0.5 mA/cm². In some embodiments, the electronic devices of the present disclosure have an areal capacitance ranging from about 150 mF/cm² to about 2000 mF/cm² at a current density of 0.5 mA/cm². In some embodiments, the electronic devices of the present disclosure have an areal capacitance ranging from about 200 mF/cm² to about 2000 mF/cm² at a current density of 0.5 mA/cm². In some embodiments, the electronic devices of the present disclosure have an areal capacitance ranging from about 300 mF/cm² to about 2000 mF/cm² at a current density of 0.5 mA/cm². In some embodiments, the electronic devices of the present disclosure have an areal capacitance ranging from about 100 mF/cm² to about 1000 mF/cm² at a current density of 0.5 mA/cm². In some embodiments, the electronic devices of the present disclosure have an areal capacitance ranging from about 100 mF/cm² to about 500 mF/cm² at a current density of 0.5 mA/cm². In some embodiments, the electronic devices of the present disclosure have an areal capacitance ranging from about 100 mF/cm² to about 300 mF/cm² at a current density of 0.5 mA/cm².

In some embodiments, the electronic devices of the present disclosure have an areal energy density ranging from about 1 μWh/cm² to about 400 μWh/cm² at a current density of 0.5 mA/cm². In some embodiments, the electronic devices of the present disclosure have an areal energy density ranging from about 1 μWh/cm² to about 200 μWh/cm² at a current density of 0.5 mA/cm². In some embodiments, the electronic devices of the present disclosure have an areal energy density ranging from about 5 μWh/cm² to about 140 μWh/cm² at a current density of 0.5 mA/cm². In some embodiments, the electronic devices of the present disclosure have an areal energy density ranging from about 1 μWh/cm² to about 100 μWh/cm² at a current density of 0.5 mA/cm². In some embodiments, the electronic devices of the present disclosure have an areal energy density ranging from about 1 μWh/cm² to about 50 μWh/cm² at a current density of 0.5 mA/cm².

In some embodiments, the electronic devices of the present disclosure have an areal power density ranging from about 100 μW/cm² to about 100 mW/cm². In some embodiments, the electronic devices of the present disclosure have an areal power density ranging from about 500 μW/cm² to about 25 mW/cm². In some embodiments, the electronic devices of the present disclosure have an areal power density ranging from about 600 μW/cm² to about 25 mW/cm². In some embodiments, the electronic devices of the present disclosure have an areal power density ranging from about 1000 μW/cm² to 25 m W/cm². In some embodiments, the electronic devices of the present disclosure have an areal power density ranging from about 100 μW/cm² to about 3,000 μW/cm². In some embodiments, the electronic devices of the present disclosure have an areal power density ranging from about 500 μW/cm² to about 2,500 μW/cm². In some embodiments, the electronic devices of the present disclosure have an areal power density ranging from about 1,000 μW/cm² to about 2,500 μW/cm².

In some embodiments, the electronic devices of the present disclosure retain at least 90% of their original capacitance value after more than 10,000 cycles. In some embodiments, the electronic devices of the present disclosure retain at least 95% of their original capacitance value after more than 10,000 cycles. In some embodiments, the electronic devices of the present disclosure retain at least 98% of their original capacitance value after more than 10,000 cycles. In some embodiments, the electronic devices of the present disclosure retain at least 99% of their original capacitance value after more than 10,000 cycles.

In some embodiments, the electronic devices of the present disclosure retain at least 80% of their original capacitance value after more than 2,000 cycles. In some embodiments, the electronic devices of the present disclosure retain at least 90% of their original capacitance value after more than 2,000 cycles. In some embodiments, the electronic devices of the present disclosure retain at least 95% of their original capacitance value after more than 2,000 cycles. In some embodiments, the electronic devices of the present disclosure retain at least 99% of their original capacitance value after more than 2,000 cycles.

The electronic devices of the present disclosure may also have various flexibilities. For instance, in some embodiments, the electronic devices of the present disclosure have bending angles that range from about 0° to about 180° at a scan rate of 40 mV/s. In some embodiments, the electronic devices of the present disclosure have bending angles that range from about 45° to about 180° at a scan rate of 40 mV/s. In some embodiments, the electronic devices of the present disclosure have bending angles that range from about 90° to about 180° at a scan rate of 40 mV/s. In some embodiments, the electronic devices of the present disclosure have bending angles that range from about 135° to about 180° at a scan rate of 40 mV/s.

Advantages

The methods of the present disclosure can provide facile and scalable approaches for the fabrication of various graphene hybrid materials that can be used as components of various electronic devices. Furthermore, as described in more detail herein, electronic devices that have the graphene hybrid materials of the present disclosure can display superior electrical properties. As such, the graphene hybrid materials of the present disclosure can be utilized in various electronic devices for numerous applications.

### Additional Embodiments

Reference will now be made to more specific embodiments of the present disclosure and experimental results that provide support for such embodiments. However, Applicants note that the disclosure below is for illustrative purposes only and is not intended to limit the scope of the claimed subject matter in any way.

### EXAMPLE 1

### High-Performance Pseudocapacitive Microsupercapacitors from Laser Induced Graphene

Microsupercapacitors provide an important complement to batteries in miniaturized electronic devices. Here, Applicants demonstrate a simple method for the scalable fabrication of all-solid-state, flexible, symmetric and asymmetric microsupercapacitors (MSCs) from laser induced graphene on commercial polyimide films and then electrodeposition of pseudocapacitive materials (manganese dioxide, ferric oxyhydroxide, and polyaniline) on the interdigitated in-plane architectures.

The microsupercapacitors in this Example demonstrate a high areal capacitance of 934 mF/cm² and a high volumetric energy density of 3.2 mWh/cm³ while being mechanically flexible with high cycling stability. The performance values are comparable to those seen in commercial lithium thin film batteries, yet two orders of magnitude higher power density than batteries.

In this Example, a CO₂ laser is first used to convert a polyimide film (PI) into porous LIG with an interdigitated architecture, which works not only as electrochemical double layer capacitance (EDLC) electrodes, but also as a flexible and conductive matrix for the electrodeposition of pseudocapacitive materials.

Two types of pseudocapacitive materials, manganese dioxide (MnO₂) or ferric oxyhydroxide (FeOOH), and polyaniline (PANI), representing characteristic transition metal oxides and conductive polymers, are electrodeposited onto the LIG forming LIG-MnO₂, LIG-FeOOH, and LIG-PANI composites. They are then assembled into all-solid-state flexible symmetric LIG-MnO₂-MSCs and LIG-PANI-MSCs, and asymmetric MSCs using LIG-FeOOH as a negative electrode and LIG-MnO₂ as a positive electrode (LIG-FeOOH//LIG-MnO₂) that are free of current collectors, binders, and separators due to the well-defined patterns that avoid short circuiting the electrodes. All of these devices demonstrate comparable energy densities to microbatteries without sacrificing their good rate performance, cycling stability, and mechanical flexibility.

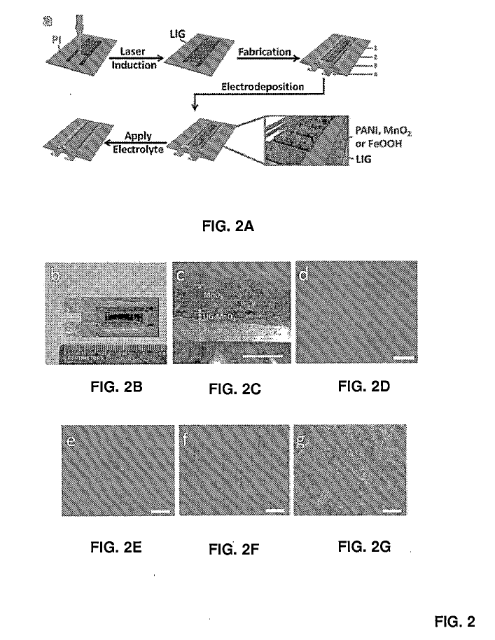

The two-step syntheses of the hybrid materials, LIG-MnO₂, LIG-FeOOH, and LIG-PANI, and the fabrication into MSCs are shown in FIG. 2A. CO₂ laser induction of the PI substrate was first conducted to form patterned LIG with 12 in-plane interdigitated electrodes (6 per polarity), onto which the pseudocapacitive materials, MnO₂, FeOOH, or electrically conductive PANI, were electrodeposited to form the composites of LIG-MnO₂, LIG-FeOOH, or LIG-PANI. The amount of MnO₂, FeOOH, or PANI in the composites was easily controlled by adjusting the deposition time or cycles, and here labeled as LIG-MnO₂—X and LIG-FeOOH—X, (where X represents the deposition time), and LIG-PANI-Y (where Y represents the number of deposition cycles).

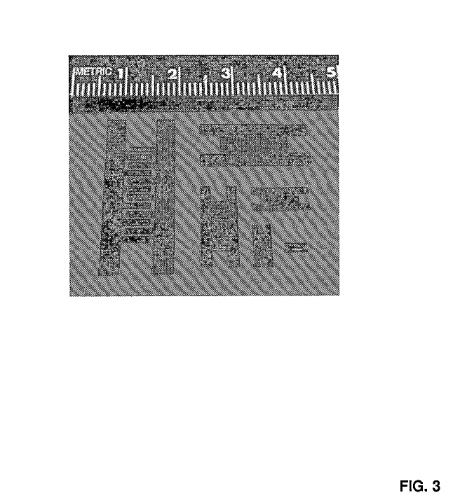

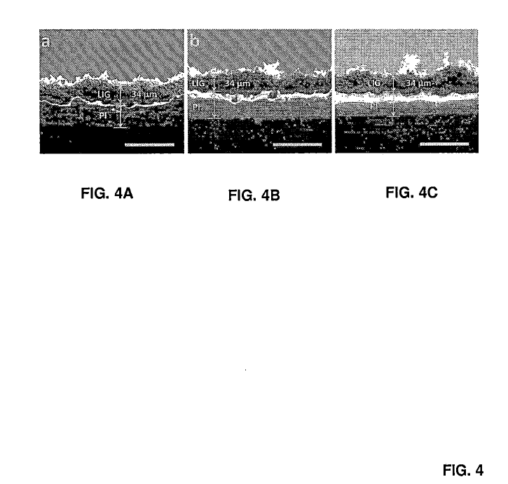

Solid-state polymer electrolyte containing poly(vinyl alcohol) (PVA) was used to complete the fabrication of the MSC devices. MSCs of various sizes can be prepared on demand by computer-controlled patterning in air at room temperature during the laser induction process (FIG. 3). FIG. 2B shows a digital photograph of one fully fabricated MSC device using this method. FIG. 2C shows the cross-sectional scanning electron microscopy (SEM) images of LIG-MnO₂-2.5 h, in which MnO₂ was observed to deposit into the LIG layer. The average thickness of the composite depends on the electrodeposition time or cycles and increases from 34 μm of LIG alone to 101 μm of LIG-MnO₂-4.0 h, 76 μm of LIG-PANI-15, and 41 μm of LIG-FeOOH-1.5 h (FIGS. 4-7).

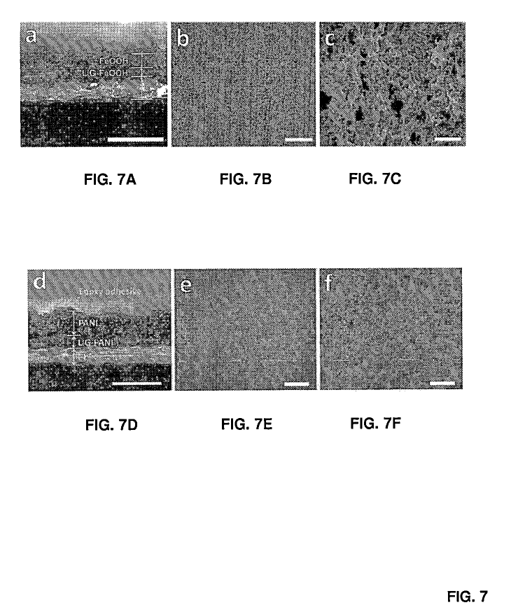

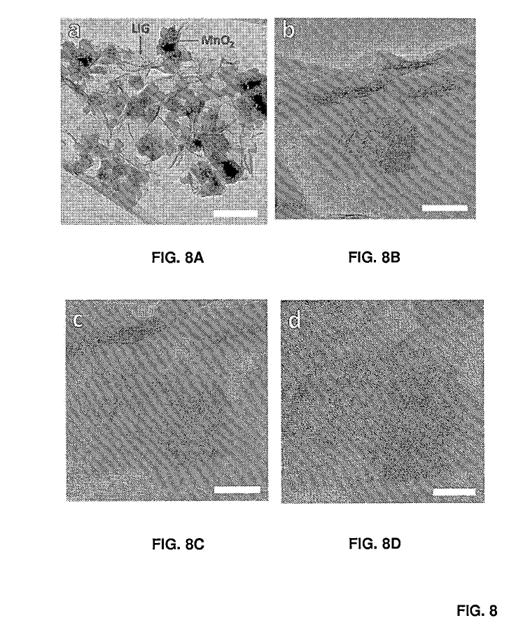

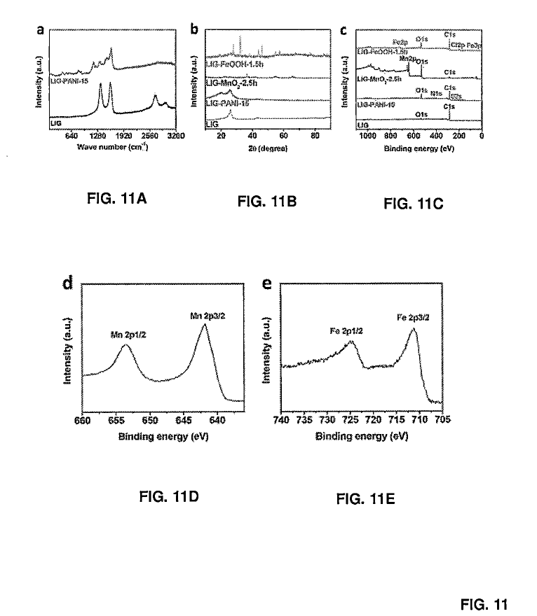

FIGS. 2D-G show the top view scanning electron microscopy (SEM) images of LIG and MnO₂, respectively. While LIG forms a porous thin film structure that could work as a conductive matrix for the subsequent electrodepositions, the deposited MnO₂ forms a flower shape. The cross-sectional and top view SEM images of LIG-FeOOH and LIG-PANI are also provided in FIG. 7. The morphologies of LIG-MnO₂, LIG-FeOOH, and LIG-PANI are further characterized by transmission electron microscopy (TEM), as shown in FIGS. 8-10. Crystallized MnO₂, FeOOH, and nanofibril PANI were found to directly deposit onto the LIG. Raman spectroscopy, X-ray diffraction (XRD), and X-ray photoelectron spectroscopy (XPS) were also used to study the composite compositions (FIG. 11).

### EXAMPLE 1.1

### Electrochemical Characterization

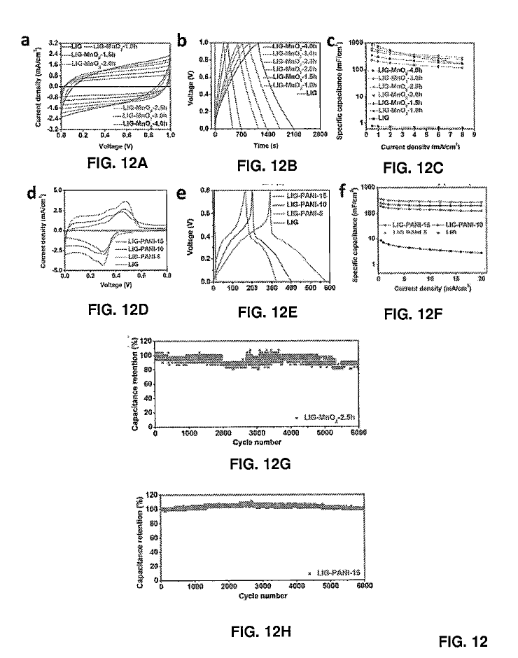

Applicants first studied the electrochemical performance of LIG-MnO₂-MSCs with LiCl/PVA as the electrolyte using cyclic voltammetry (CV) and galvanostatic charge-discharge experiments in a potential window from 0 to 1.0 V. FIG. 12A shows the CV curves of LIG-MnO₂-X and LIG at a scan rate of 5 mV/s. Although LIG is known to contribute capacitance by the EDLC mechanism, the CV curve of LIG is minuscule compared to those of LIG-MnO₂—X, demonstrating that most of the capacitance comes from the pseudocapacitance of MnO₂. Also, aside from the much larger CV curve area, the pseudo-rectangular CV shape of LIG-MnO₂—X indicates good capacitive behavior.

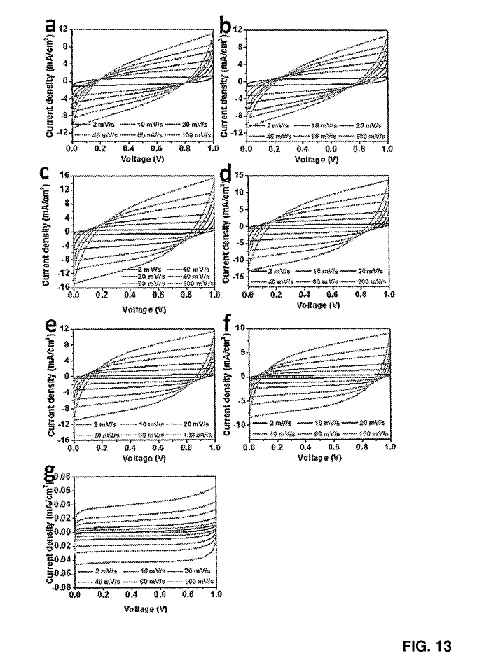

FIG. 13 shows CV curves of LIG-MnO₂—X at a scan rate ranging from 2 to100 mV/s, demonstrating a proportional current increase with an increasing scan rate. Without being bound by theory, it is envisioned that the distorted CV shapes of the samples with more MnO₂ content at high scan rates may result from the decreased electrical conductivity. FIG. 12B shows the galvanostatic charge-discharge curves of LIG-MnO₂—X at a current density of 0.5 mA/cm². The curve from LIG alone is nearly negligible, again demonstrating little contribution in capacitance from LIG in the composite of LIG-MnO₂, which is consistent with the CV analyses.

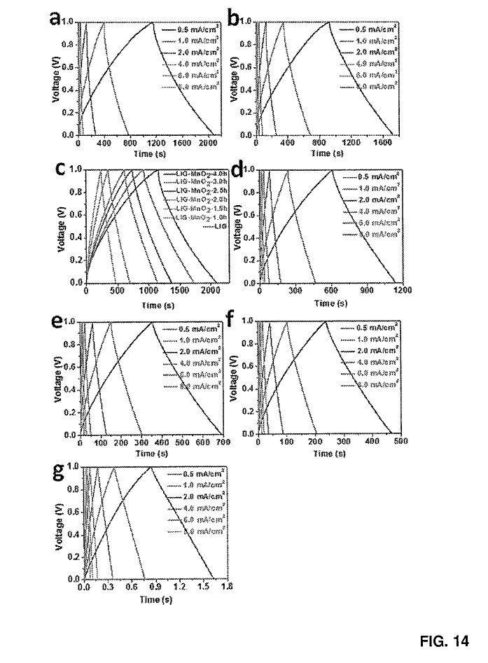

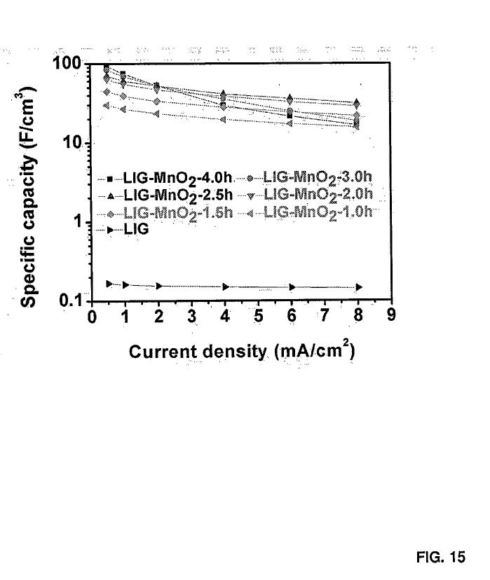

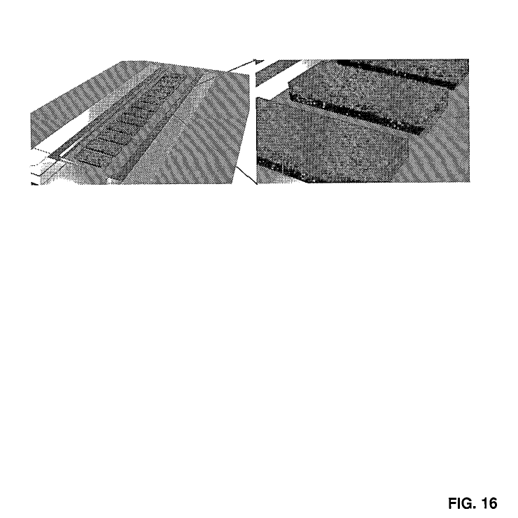

FIG. 14 further shows the galvanostatic charge-discharge curves of these samples at varying current densities. The nearly symmetrical charging and discharging curves and small voltage drops at initial discharge states indicate good capacitive behavior and high conductivity within the electrodes. Based on the galvanostatic charge-discharge curves, the areal and volumetric specific electrode capacitance of LIG-MnO₂—X are calculated and plotted in FIGS. 12C and 15. Here, the total area of each MSC device (A_{Device}) includes the interdigitated electrodes and the spaces between them, and the volume is equal to A_{Device} multiplied by the height of the composite (FIG. 16).

More MnO₂ content in the LIG-MnO₂ composite results in a higher capacitance at low current density, as evidenced by the highest areal and volumetric specific capacitances of 934 mF/cm² and 93.4 F/cm³, respectively, from LIG-MnO₂-4.0 h at a current density of 0.5 mA/cm². At the same current density, the areal and volumetric specific capacitance of LIG alone is less than 0.8 mF/cm² and 0.2 F/cm³, indicating that most of the capacitance is coming from the pseudocapacitance of MnO₂ in the LIG-MnO₂ composite. With increasing current density, the capacitance from the sample with less MnO₂ decreases more slowly. At a high current density of 8.0 mA/cm², the specific capacitance of LIG-MnO₂-2.5 h is maximized, with an areal value of 281 mF/cm² and a volumetric value of 31.5 F/cm³, most likely due to the relatively higher conductivity of the LIG-MnO₂ composite when less MnO₂ was deposited.

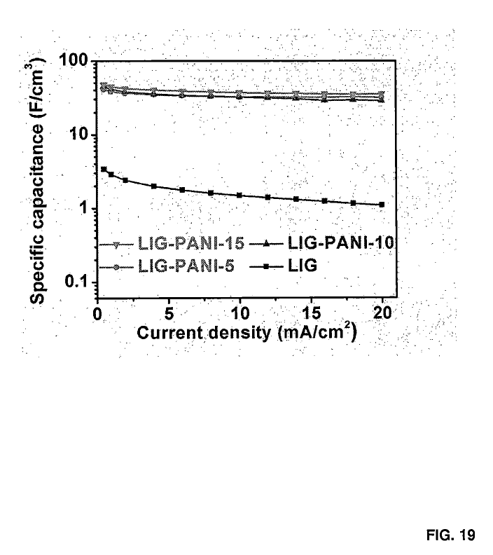

LIG-PANI-MSCs using H₂SO₄/PVA as the electrolyte were also studied from CV and galvanostatic charge discharge experiments in a potential window from 0 to 0.8 V (FIGS. 12D-E and 17-18). FIGS. 12F and 19 show the calculated areal and volumetric specific electrode capacitance of LIG-PANI-Y. LIG-PANI-15 has the best performance among all the samples with an areal and volumetric specific capacitance of 361 mF/cm² and 47.5 F/cm³, respectively, at a current density of 0.5 mA/cm². In comparison, LIG itself is only 8.4 mF/cm² and 1.8 F/cm³ at the same current density. When the current density increases to 20 mA/cm², the specific capacitance of LIG-PANI-15 still remains at 271 mF/cm² and 35.6 F/cm³ with a high capacitance retention of 75%, indicating the good rate performance of LIG-PANI-15. The cyclability of the fabricated devices from LIG-MnO₂ and LIG-PANI were also tested. After 6000 cycles of charge-discharging test, the capacitance of LIG-MnO₂-2.5 h and LIG-PANI-15 remained over 82% and 97%, respectively, showing optimal stability of the devices based on these hybrid composites (FIGS. 12G-H).

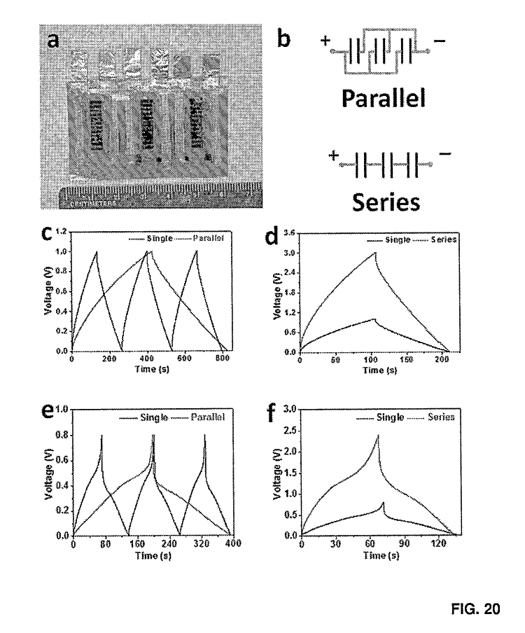

To meet the specific energy and power needs for practical applications, multiple MSCs from LIG-MnO₂ or LIG-PANI can also be scaled up and assembled in either series or parallel configurations (FIG. 20). Compared with a single MSC, the discharge time of three MSCs connected in parallel increased to 3× that of a single MSC when operated at the same current density. When the three MSCs were connected in series, it exhibited three times higher voltage window with a similar discharge time at the same current density.

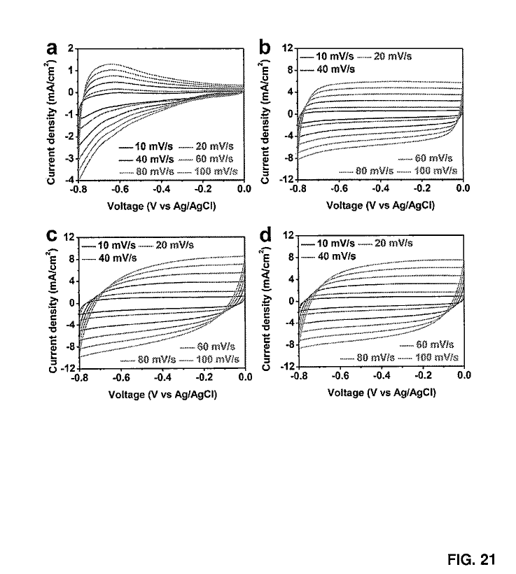

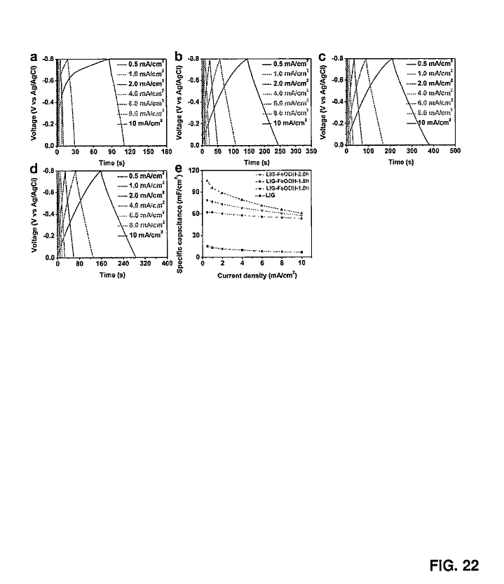

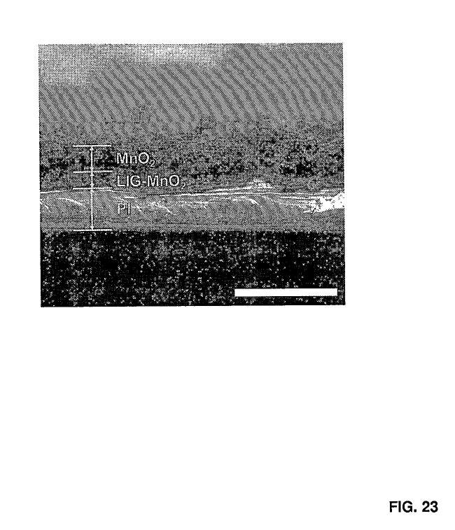

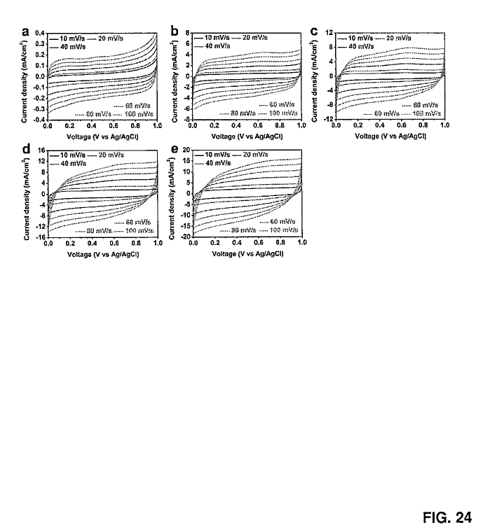

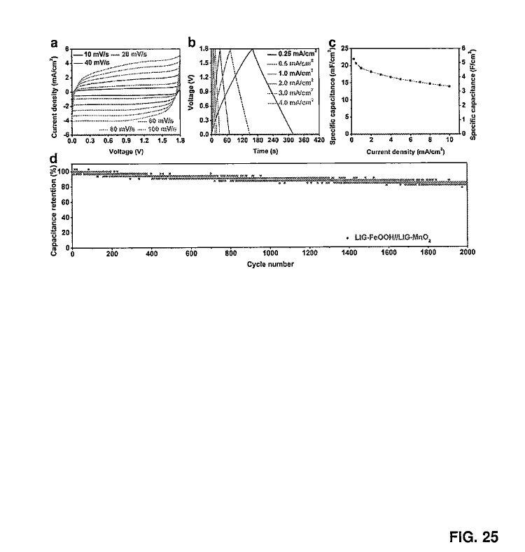

An alternative way to increase the voltage output is to make the asymmetric MSCs. Here, asymmetric MSCs of LIG-FeOOH//LIG-MnO₂ were constructed using LIG-FeOOH in the negative electrodes (FIGS. 21-22) and LIG-MnO₂ in the positive electrodes (FIGS. 23-24) while PVA/LiCl was used as the solid-state electrolyte. FIG. 25A shows the CV curves of LIG-FeOOH//LIG-MnO₂ at different scan rates in the potential window of 0 to 1.8 V. Its nearly rectangular CV shape is indicative of good capacitive behavior. This is further supported by the triangular galvanostatic charge discharge curves in the same potential window, as shown in FIG. 25B.

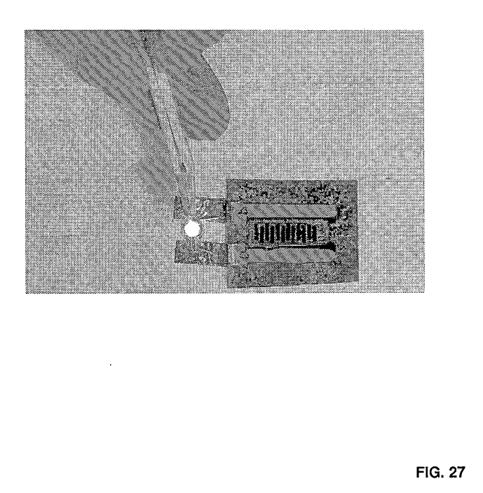

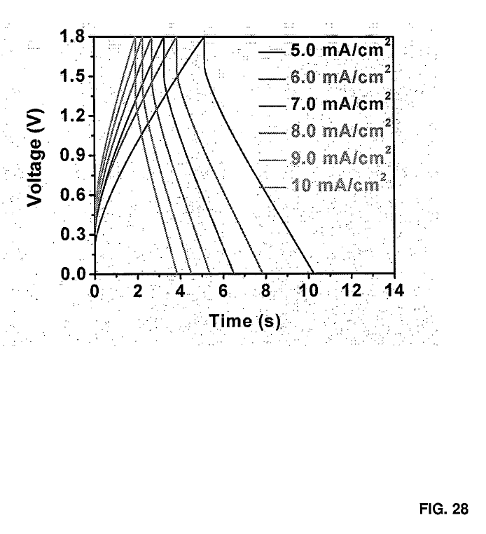

The working voltage increased from 1.0 V in the case of LIG-MnO₂ symmetric MSCs to 1.8 V in LIG-FeOOH//LIG-MnO₂ asymmetric MSCs. One of the asymmetric MSCs can power a light emitting diode (LED) (1.7 V, 30 mA) (FIG. 27). Capacitance of the asymmetric MSCs is calculated based on charge discharge curves in FIGS. 25B and 28.

Areal and volumetric capacitances of LIG-FeOOH//LIG-MnO₂ (full device capacitance) are 21.9 mF/cm² and 5.4 F/cm³, respectively, at a current density of 0.25 mA/cm² (FIG. 25C). When the current density increases to 10 mA/cm², 64% capacitance retention is seen. The cycling life of LIG-FeOOH//LIG-MnO₂ is also evaluated by the extended galvanostatic charge discharge cycles. As shown in FIG. 25D, 84% capacitance is retained after 2000 cycles, demonstrating a promising cycling stability.

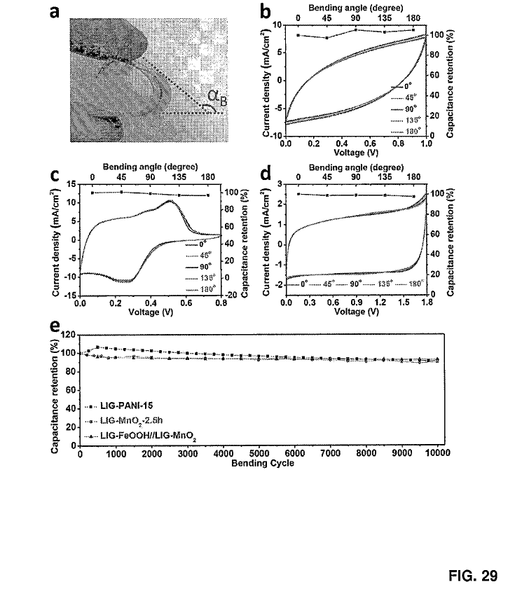

The flexibility of MSCs from LIG-MnO₂-2.5 h, LIG-PANI-15, and LIG-FeOOH//LIG-MnO₂ was also studied, as shown in FIG. 29. The digital image of one MSC device that is manually bent with a bending angle (α_{B}) of ˜135° is shown in FIG. 29A. The CV curves at different α_{B} are nearly overlapping with each other, and the calculated capacitance remains almost the same, indicating the stable performance of LIG-MnO₂, LIG-PANI, and LIG-FeOOH//LIG-MnO₂ at these states (FIGS. 29B-D). The flexibility tests carried out by bending the device with a α_{B} of ˜90° (FIG. 29E) show a good mechanical flexibility of these materials with only 10% capacitance decay after 10000 bending cycles. Some small increase in performance at early cycles can be attributed to enhanced electrolyte penetration into the LIG-PANI-15. These results demonstrate that all three of the MSCs, LIG-MnO₂-2.5 h, LIG-PANI-15, and LIG-FeOOH//LIG-MnO₂, are effective flexible MSCs.

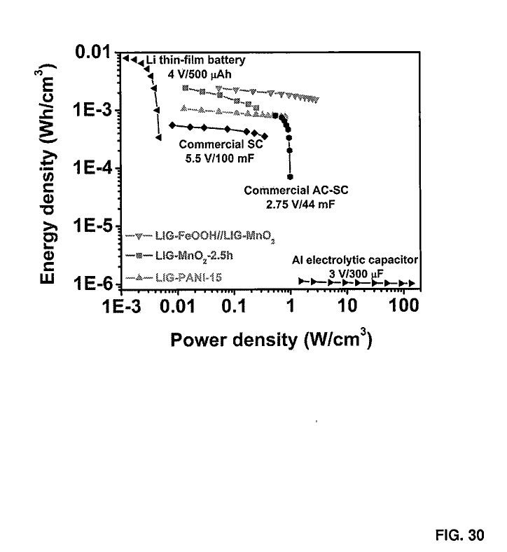

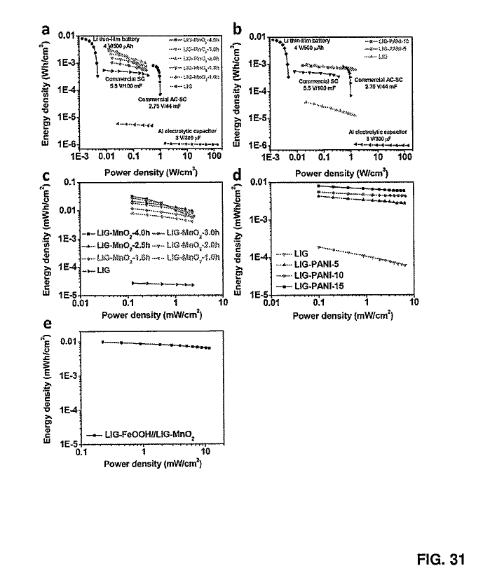

Unlike traditional supercapacitors where the performance is evaluated per weight of the active material, the footprint area of MSCs becomes the key consideration, making the spacial energy and power density the most important performance metrics. FIGS. 30 and 31 show the Ragone plots demonstrating the areal and volumetric energy and power density of LIG-related MSCs, and their comparison with commercially available energy storage devices. In the LIG-MnO₂-MSCs, the highest energy densities are 32.4 μWh/cm² and 3.2 mWh/cm³, which is an increase of >1200 and >290 times, respectively, compared with LIG at a current density of 0.5 mA/cm² (Table 1). For LIG-PANI-MSCs, the highest energy densities are 8.0 μWh/cm² and 1.1 mWh/cm³, which are 41 and 15 times higher, respectively, than that of LIG at a current density of 0.5 mA/cm² (Table 1).

TABLE 1
Electrochemical performances of MSCs of LIG-MnO₂, LIG-PANI, and
LIG-FeOOH//LIG-MnO₂ with interdigitated architectures in plane.

| | | Specific capacitance^{a} | | Energy density^{a} | | Power density^{b} | |
|---|---|---|---|---|---|---|---|
| | | Areal | Volumetric | Areal | Volumetric | Areal | Volumetric |
| Electrode | Electrolyte | (mF/cm²) | (F/cm³) | (μWh/cm²) | (mW/cm³) | (μWh/cm²) | (mW/cm³) |
| LIG-PANI-15 | PVA/H₂SO₄ | 360.8 | 47.5 | 8.0 | 1.1 | 629.5 | 828.3 |
| LIG-PANI-10 | PVA/H₂SO₄ | 250.1 | 45.0 | 5.6 | 0.9 | 676.2 | 1108.6 |
| LIG-PANI-5 | PVA/H₂SO₄ | 193.3 | 41.0 | 4.3 | 1.0 | 649.9 | 1511.4 |
| LIG | PVA/H₂SO₄ | 8.4 | 1.8 | 1.9 × 10⁻¹ | 4.0 × 10⁻² | 653.9 | 1391.3 |
| LIG-MnO₂-4.0 h | PVA/LICl | 933.6 | 92.4 | 32.4 | 3.2 | 2334.0 | 231.1 |
| LIG-MnO₂-3.0 h | PVA/LICl | 799.6 | 83.3 | 27.8 | 2.89 | 2462.5 | 256.5 |
| LIG-MnO₂-2.5 h | PVA/LICl | 623.8 | 70.1 | 21.7 | 2.5 | 2248.0 | 252.6 |
| LIG-MnO₂-2.0 h | PVA/LICl | 524.2 | 63.2 | 18.2 | 2.2 | 2293.4 | 276.3 |
| LIG-MnO₂-1.5 h | PVA/LICl | 339.4 | 44.7 | 11.8 | 1.6 | 2265.7 | 298.1 |
| LIG-MnO₂-1.0 h | PVA/LICl | 229.0 | 30.2 | 8.0 | 1.0 | 2256.7 | 297.0 |
| LIG | PVA/LICl | 0.8 | 1.7 × 10⁻¹ | 2.7 × 10⁻³ | 5.8 × 10⁻³ | 2287.2 | 486.3 |
| LIG-FeOOH //LIG-MnO₂^{c} | PVA/LICl | 21.9 | 5.4 | 9.9 | 2.4 | 11853.3 | 2891 |

Notes:
^{a}The specific capacitance and the energy density was calculated at the current density of 0.5 mA/cm².
^{b}The power density of these samples was obtained at 20.0 mA/cm² for LIG-PANI, and 8.0 mA/cm² for LIG-MnO₂, and 10.0 mA/cm² for LIG-FeOOH//LIG-MnO₂.
^{c}The capacitance of LIG-FeOOH//LIG-MnO₂ is the device capacitance, not the specific capacitance of the electrodes.

For LIG-FeOOH//LIG-MnO₂, the energy densities are 9.6 μWh/cm² and 2.4 mWh/cm³, respectively. Such energy densities from LIG-MnO₂, LIG-PANI, and LIG-FeOOH//LIG-MnO₂ are much higher than some typical commercial supercapacitors (SCs) (2.75 V/44 mF and 5.5 V/100 mF), and even comparable to Li thin-film batteries (4 V/500 μAh). The maximum areal and volumetric power densities are 2334 μW/cm² and 298 mW/cm³ for LIG-MnO₂, 649 μW/cm² and 1511 mW/cm³ for LIG-PANI, and 11853 μW/cm² and 2891 mW/cm³ for FeOOH//LIG-MnO₂, which are comparable to commercial SCs, and >100 times higher than in Li thin-film batteries.

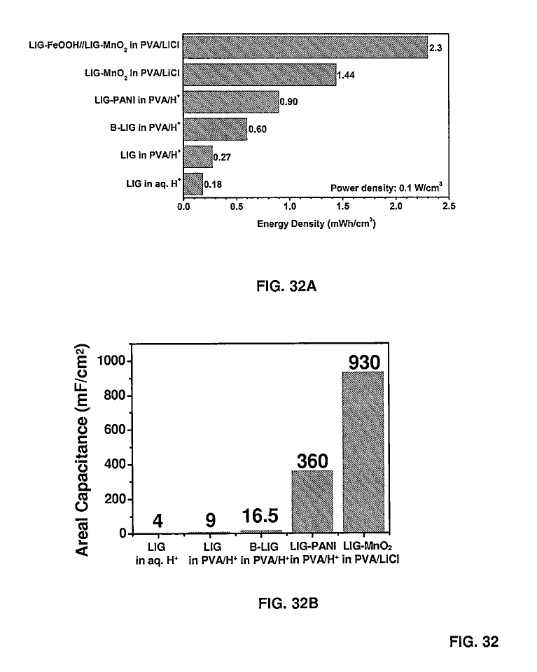

The performance of the aforementioned MSCs show much better performance than Applicants' previously studied LIG-MSCs and boron doped LIG-MSCs in aqueous or polymeric acidic electrolyte (FIG. 32), and also better performance than most other reported carbon and pseudocapacitive materials as shown in Table 2.

TABLE 2
Electrochemical performances of MSCs based on carbon materials and pseudocapacitive
active materials with in-plane interdigital architectures.

| | | Specific capacitance | | Energy density | | Power density | | |
|---|---|---|---|---|---|---|---|---|
| | | Areal | Volumetric | Areal | Volumetric | Areal | Volumetric | |
| Electrode^{a} | Electrolyte | (mF/cm²) | (F/cm³) | (μWh/cm²) | (mW/cm³) | (μWh/cm²) | (W/cm³) | References |
| AC | 1M Et4NBF₄ in PC | 11.6 at | 9.0 at | — | 18 | — | 41 | 15 |
| | | 0.5 V/s | 0.01 V/s | | | | | |
| OLC | 1M Et4NBF₄ in PC | 1.7 at | 1.3 at | — | ~1.7 | — | 200-250 | 15 |
| | | 1 V/s | 1 V/s | | | | | |
| AC | 1M Et4NBF₄ in PC | 2.1 at | 2.7 at | — | — | 44900 | — | 16 |
| | | 1 mV/s | 1 mV/s | | | | | |
| CNTs | BMIM/BF₄ | 0.428 | — | — | — | 280 | — | 17 |
| rGO | Hydrated GO | 0.51 | 3.1 | — | 0.43 | — | 9.4 | 18 |
| G/CNTs | 1M Na₄SO₄ | 2.16 at | 1.08 at | — | 0.16 | — | 115 | 19 |
| | | 0.1 mV/s | 0.1 mV/s | | | | | |
| Graphene | PVA-H₂SO₄ | 0.3228 at | 71.6 at | — | 2.5 | — | 495 | 20 |
| | | 0.01 V/s | 0.01 V/s | | | | | |
| GQDs//MnO₂ | 0.5 Na₄SO₄ | 1.107 at | — | 0.154 | — | 7.51 | — | 21 |
| | | 15 μA/cm² | | | | | | |
| MnO₂ | — | 56.3 at | — | 5.01 | — | 12020 | — | 22 |
| | | 17.2 μA/cm² | | | | | | |
| NiO | 1M KOH | 1.24at | — | 1.0 | — | 40000 | — | 23 |
| | | 7.7 mA/cm² | | | | | | |
| VS₄ | PVA-BMIMBF₄ | 4.76 | — | — | — | — | — | 24 |
| PPV/C-MEMS | 1M KCl | 78.35 at | — | — | — | 630 ± 40 | — | 25 |
| | | 20 mV/s | | | | | | |
| PANI | PVA-H₂SO₄ | 23.52 at | 588 at | — | 82 | — | 25 | 26 |
| | | 0.1 mA/cm³ | 0.1 mA/cm² | | | | | |

Notes:
^{a}AC: activated carbon, OLC: onion like carbon, CNTs: carbon nanotubes, rGO: reduced graphene oxide, G/CNTs: graphene/carbon nanotubes, GQDs//MnO₂: graphene quantum dots//MnO₂, PPy/C-MEMS: Polypyrrole/Carbon-microelectrochemical system, PANI: polyaniline.

In most of the results in Table 2, high-cost lithography for electrode patterning and often high temperature and multi-step synthetic processes are required. In this Example, the synthesis and patterning of LIG are simultaneously achieved in the first step, and both the laser induction step and subsequent electrodepositions are done under mild temperature and ambient atmosphere.

In sum, Applicants have demonstrated a simple route to make all-solid-state flexible MSCs with interdigitated electrodes using a hybrid composite of LIG. The room temperature and ambient air-based laser induction is followed by MnO₂, FeOOH, or PANI electrodeposition. The solid-state flexible symmetric MSCs of LIG-MnO₂ and LIG-PANI, and asymmetric MSCs of LIG-FeOOH//LIG-MnO₂, demonstrate high specific capacitances, promising energy and power densities, and optimal cycling stabilities and mechanical flexibilities. These findings not only simplify device fabrication processes with easy control of the size of devices and scalability, but also demonstrates the applicability of the LIG technique to a wide range of other pseudocapacitive materials, beyond that of MnO₂, FeOOH, and PANI. Therefore, the design strategy developed in this Example is broadly applicable.

### EXAMPLE 1.2

### Synthesis and Fabrication of LIG

The synthesis and patterning of LIG from a polyimide sheet was done as described previously. See ACS Appl. Mater. Inter. 7, 3414-3419 (2015) and Nat. Commun. 5, 5714 (2014). Kapton® polyimide films (McMaster-Carr, Cat. No. 2271K3, thickness: 0.005″) were used as received. LIG was generated using a CO₂ laser cutter system (Universal X-660 laser cutter platform) on Kapton® polyimide film at a power of 4.8 W. All samples were prepared under room temperature and ambient air.

LIG was patterned into 12 interdigitated electrodes with a length of 4.1 mm, a width of 1 mm, and a spacing of ˜300 μm between two neighboring microelectrodes (FIG. 15). After that, Pellco® colloidal silver paint (No. 16034, Ted Pella) was first applied on the common areas of both electrodes for better electrical contact. The electrodes were then extended with conductive copper tape, which were connected to an electrochemical workstation for testing. A Kapton® polyimide tape was employed followed by an epoxy (Machineable-fast set, Reorder #04002, Hardman®) sealing to protect the common areas of the electrodes from electrolyte.

### EXAMPLE 1.3

### Synthesis of LIG-MnO₂

Electrodeposition of MnO₂ on LIG was achieved with a three-electrode setup. LIG on a PI sheet served as the working electrode, which was immersed into an aqueous solution containing 0.01 M Mn(CH₃COO)₂ at ˜60° C. Platinum foil (Sigma-Aldrich) was the counter electrode and Ag/AgCl (Fisher Scientific) was the reference electrode. A constant current density of 1 mA/cm² was applied for a designated time to ensure good deposition of MnO₂ on the sample. The amount of MnO₂ onto LIG was controlled by adjusting the deposition time. After electrodeposition, the sample was withdrawn and washed with deionized water to remove excess electrolyte, and then placed in a vacuum desiccator overnight (˜120 mm Hg).

### EXAMPLE 1.4

### Synthesis of LIG-FeOOH

Electrodeposition of FeOOH on LIG was achieved with a two-electrode setup. LIG on a PI sheet served as the working electrode, which was immersed into an aqueous solution containing 0.1 M FeCl₃. The pH of FeCl₃ solution was 2, adjusted by 1.0 M HCl. Ag/AgCl (Fisher Scientific) worked as the reference electrode and counter electrode. A constant current density of 15 mA/cm² was applied for a designated time to ensure sufficient deposition of FeOOH on the sample. The amount of FeOOH onto LIG was controlled by adjusting the deposition time. After electrodeposition, the sample was withdrawn and washed with deionized water to remove excess electrolyte, and then placed in a vacuum desiccator overnight (˜120 mm Hg).

### EXAMPLE 1.5

### Synthesis of LIG-PANI

Electrodeposition of PANI on LIG was achieved with a three-electrode setup. LIG on a PI sheet served as the working electrode, which was immersed into an aqueous solution containing 0.1 M aniline and 1.0 M H₂SO₄. With a platinum counter electrode and Hg/HgCl₂ (Fisher Scientific) reference electrode, PANI was electrochemically deposited onto LIG by cycling within the potential window from −0.20 V to 0.95 V vs. Hg/HgCl₂. The amount of PANI onto LIG was controlled by the cycle number of deposition. After electrodeposition, LIG-PANI was treated with 1.0 M H₂SO₄ for 1 hour. A uniform dark green film was obtained after washing with deionized water to remove excess electrolyte and drying in a vacuum desiccator overnight (˜120 mm Hg).

### EXAMPLE 1.6

### Fabrication of the Flexible All-Solid-State MSCs

Polymeric gel electrolytes of PVA/LiCl and PVA/H₂SO₄ were prepared according to previously reported methods. See Nat. Commun. 4, 1475 (2013) and ACS Nano 6, 10296-10302 (2012). The electrolytes were then used in LIG-MnO₂ and LIG-FeOOH//LIG-MnO₂, and LIG-PANI, respectively. For PVA/LiCl, it was made by stirring 10 mL of DI water, 2.0 g of LiCl (Sigma-Aldrich), and 1.0 g of PVA (M_{w}=50000, Aldrich No. 34158-4) at 80° C. overnight. For PVA/H₂SO₄, it was made by stirring 10 mL of DI water, 1.0 mL of sulfuric acid (98%, Sigma-Aldrich), and 1.0 g of PVA at 80° C. overnight. About 0.25 mL of the electrolyte was applied to the active area of the devices, and was dried under ambient conditions for 4 hours. The all-solid-state MSCs were obtained after drying in a vacuum desiccator (˜120 mm Hg) overnight for further solidification of the electrolyte.

### Example 1.7

### Electrochemical Characterization of the Flexible All-Solid-State MSCs

The electrochemical performances of the flexible all-solid-state MSCs were characterized by CV, galvanostatic charge-discharge experiments, and EIS using an electrochemical station (CHI 660D). The areal specific capacitance (C_{A}) and volumetric specific capacitance (C_{V}) of electrode materials were calculated from galvanostatic charge-discharge curves according to Eq 1 and Eq 2, respectively:

C_{A}=4I/(A_{Device}×(dV/dt)) (1)

C_{V}=4I/(V_{Device}×(dV/dt)) (2)

In the aforementioned equations, I is the current applied, A_{Device} is the total area of the device (FIG. 15), V_{Device} is the total volume of the device (FIG. 15), and dV/dt is the slope of the discharge curve. The areal capacitance (C_{Device, A}) and volumetric capacitance (C_{Device,V}) of the MSCs were calculated by using Eqs 3 and 4, respectively:

C_{Device, A}=C_{A}/4 (3)

C_{Device, V}=C_{V}/4 (4)

The areal energy density (E_{Device, A}) and volumetric energy density (E_{Device,V}) of the MSCs were calculated by using Eqs 5 and 6, respectively:

E_{Device, A}=C_{Device, A}V²/(2×3600) (5)

E_{Device, V}=C_{Device, V}V²/(2×3600) (6)

In the aforementioned equations, V is the applied voltage. The areal power density (P_{Device, A}) and volumetric power density (P_{Device,V}) of the MSCs were calculated by using Eqs 7 and 8, respectively:

P_{Device, A}=E_{Device, A}×3600/t (7)

P_{Device, V}=E_{Device, V}×3600/t (8)

In the aforementioned equations, t is the discharge time.

### EXAMPLE 1.8

### Additional Results

Additional experimental results are described herein. For instance, FIG. 3 provides a digital image of an LIG on a PI sheet with different sizes. The unit of the ruler in the image is in centimeters.

FIGS. 4A-C provide cross-sectional SEM images of LIGs taken at different locations in the same sample. All of the LIGs in this sample exhibit a height of ˜34 μm. The scale bars are 100 μm.

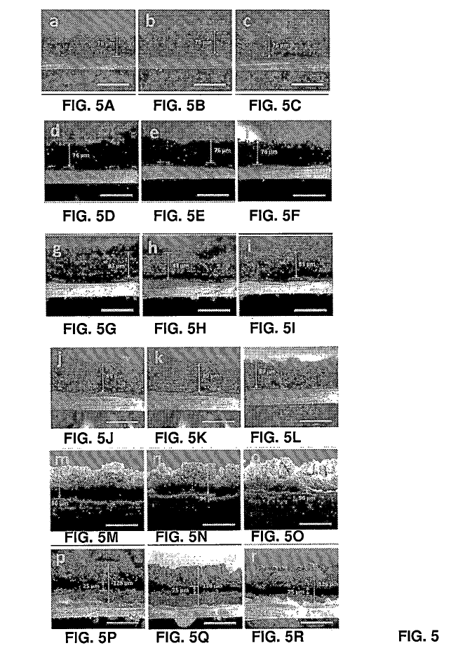

FIG. 5 shows cross-sectional SEM images of LIG-MnO₂-1.0 h (FIGS. 5A-C), LIG-MnO₂-1.5 h (FIGS. 5D-F), LIG-MnO₂-2.0 h (FIGS. 5G-I), LIG-MnO₂-2.5 h (FIGS. 5J-L), LIG-MnO₂-3.0 h (FIGS. 5M-O), and LIG-MnO₂-4.0 h (FIGS. 5P-R), indicating the height of these samples are ˜76 μm, ˜76 μm, ˜83 μm, ˜89 μm, ˜96 μm, and ˜101 μm, respectively. In the images in FIGS. 5P-R, there is a ˜25 μm vacancy between the upper and bottom layer due to sample preparation. Therefore, the actual sample height is calculated as 101 μm. The scale bars are 100 μm.

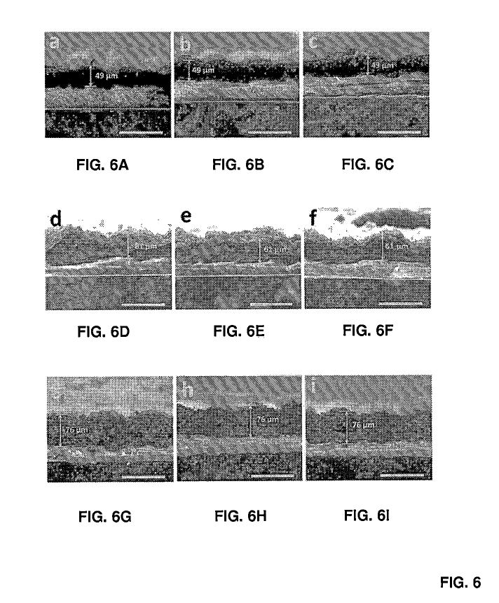

FIG. 6 provides cross-sectional SEM images of LIG-PANI-5 (FIGS. 6A-C), LIG-PANI-10 (FIGS. 6D-F), and LIG-PANI-15 (FIGS. 6G-I), indicating the height of the samples are ˜49 μm, ˜61 μm, and ˜76 μm, respectively. The scale bars are 100 μm.

FIG. 7A provides a cross-sectional SEM image of LIG-FeOOH-1.5 h, indicating a height of ˜41 μm. FIGS. 7B-C provide top view SEM images of FeOOH in LIG-FeOOH at different resolutions. FIG. 7D provides a cross-sectional SEM image of LIG-PANI. FIGS. 7E-F provide top view SEM images of PANI in LIG-PANI at different resolutions. The scale bars are 100 μm for FIGS. 7A-B and D-E, and 2 μm for FIGS. 7C and F. The lined-pattern in FIGS. 7B and E are due to the raster scanning of the laser.

FIG. 8 provides TEM images of LIG-MnO₂. FIG. 8A shows the TEM image of the LIG-MnO₂ hybrid material. FIGS. 8B-D show the TEM images of MnO₂ in LIG-MnO₂ at different resolutions. The scale bars are 400 nm for FIG. 8A, 20 nm for FIG. 8B-C, and 10 nm for FIG. 8D.

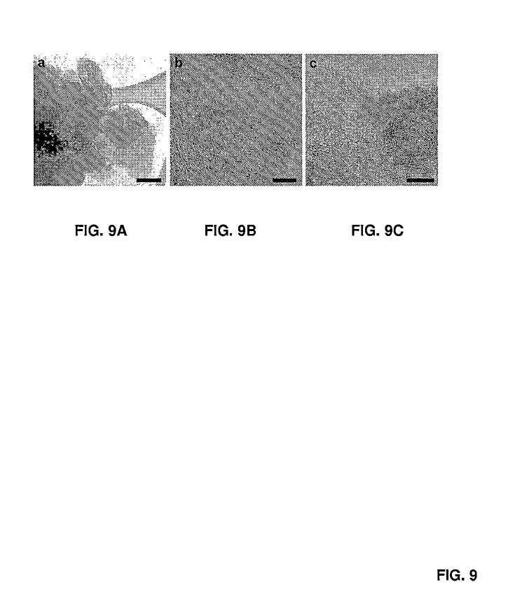

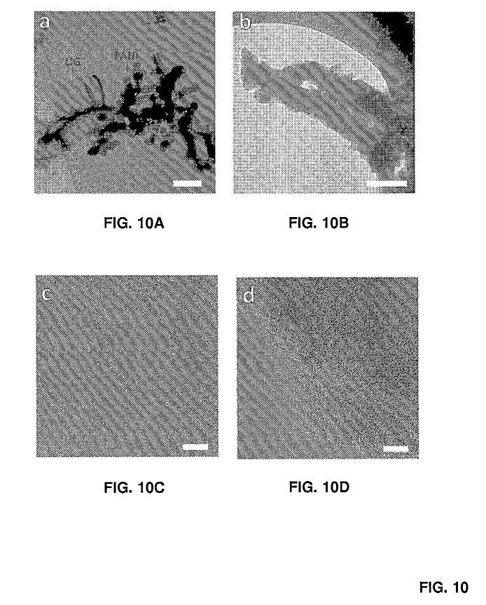

FIG. 9 provides TEM images of LIG-FeOOH. FIG. 9A provides a TEM image of the LIG-FeOOH hybrid material. FIGS. 9B-C provide the TEM images of FeOOH in LIG-FeOOH at different resolutions. The scale bar is 200 nm for FIG. 9A and 10 nm for FIGS. 9B-C.

FIG. 10 provides TEM images of the LIG-PANI hybrid material. FIG. 10A provides a TEM image of the LIG-PANI hybrid material. The scale bar is 4 μm. FIG. 10B provides a TEM image of PANI. The scale bar is 200 nm. FIG. 10C provides an HRTEM image of LIG with graphitic edges. The scale bar is 10 nm. FIG. 10D provides an HRTEM image of PANI with an amorphous character. The scale bar is 10 nm.

FIG. 11 provides various data relating to LIG hybrid materials, including the Raman spectra of LIG and LIG-PANI-15 (FIG. 11A), XRD patterns of LIG, LIG-PANI-15, LIG-MnO₂-2.5 h, and LIG-FeOOH-1.5 h (FIG. 11B), XPS spectra of LIG, LIG-PANI-15, LIG-MnO₂-2.5 h, and LIG-FeOOH-1.5 h (FIG. 11C), elemental XPS spectrum of Mn 2p for LIG-MnO₂-2.5 h (FIG. 11D), and elemental XPS spectrum of Fe 2p for LIG-FeOOH-1.5 h (FIG. 11E). The C1s peak (284.5 eV) was used as a standard to correct the data.

FIG. 11A shows the Raman spectra of LIG and LIG-PANI-15. The characteristic peaks at ˜1350 cm⁻¹, ˜1597 cm⁻¹ and ˜2707 cm⁻1 from the LIG sample represent the D band, G band and 2D bands, respectively, indicating the graphitic structure of LIG. The polyaniline peaks from 1000 cm⁻¹ to 1600 cm⁻¹ in LIG-PANI-15 sample confirm the formation of PANI.

FIG. 11B shows the XRD patterns of LIG, LIG-PANI-15, LIG-MnO₂-2.5 h, and LIG-FeOOH-1.5 h. LIG showed a strong diffraction peak (002) of graphite at 26°. LIG-PANI-15 shows two peaks centered at 15.3° and 26°, resulting from the periodicity both perpendicular and parallel to the polymer chain, respectively.

The XRD pattern of LIG-MnO₂-2.5 h can be indexed to α-MnO₂. Due to the relatively small size of the crystals, the XRD pattern peaks of MnO₂ in LIG-MnO₂-2.5 h become broad and weak. The XRD peak of LIG in LIG-MnO₂-2.5 h is covered by MnO₂. The XRD pattern of LIG-FeOOH-1.5 h can be indexed to γ-FeOOH.

FIG. 11C shows XPS spectra of LIG, LIG-PANI-15, LIG-MnO₂-2.5 h and LIG-FeOOH-1.5 h. LIG-PANI-15 contained four elements, C, N, O, and trace S from the sulfuric acid. LIG-MnO₂-2.5 h contained three main elements, C, O, and Mn. LIG-FeOOH-1.5 h contained four elements, Fe, O, C, and Cl from FeCl₃. The oxidation state of Mn in LIG-MnO₂-2.5 h is further confirmed by high-resolution XPS, as shown in FIG. 11D. The spin energy separation of Mn 2p_{3/2} and Mn 2p_{1/2} centered at 642.5 eV and 654.2 eV is 11.7 eV, which is in good agreement with reported data of Mn 2p_{3/2} and Mn 2p_{1/2} in MnO₂. The oxidation state of Fe in LIG-FeOOH-1.5 h is also studied by high-resolution XPS, as shown in FIG. 11E, confirming Fe existing in FeOOH.

FIG. 13 provides cyclic voltammetry curves for LIG-MnO₂-4.0 h (FIG. 13A), LIG-MnO₂-3.0 h (FIG. 13B), LIG-MnO₂-2.5 h (FIG. 13C), LIG-MnO₂-2.0 h (FIG. 13D), LIG-MnO₂-1.5 h (FIG. 13E), LIG-MnO₂-1.0 h (FIG. 13F), and LIG(FIG. 13G) over a scan rate range of 2 and 100 mV/s in the potential window from 0 to 1.0 V. Likewise, FIG. 14 provides galvanostatic charge discharge curves of LIG-MnO₂-4.0 h (FIG. 14A), LIG-MnO₂-3.0 h (FIG. 14B), LIG-MnO₂-2.5 h (FIG. 14C), LIG-MnO₂-2.0 h (FIG. 14D), LIG-MnO₂-1.5 h (FIG. 14E), LIG-MnO₂-1.0 h (FIG. 14F), and LIG (FIG. 14G) over a current density range of 0.5 to 8.0 mA/cm² in the potential window from 0 to 1.0 V. In addition, FIG. 15 provides volumetric specific capacitance of LIG-MnO₂-4.0 h, LIG-MnO₂-3.0 h, LIG-MnO₂-2.5 h, LIG-MnO₂-2.0 h, LIG-MnO₂-1.5 h, LIG-MnO₂-1.0 h, and LIG over a current density range of 0.5 and 8.0 mA/cm².

FIG. 16 provides the dimension of the MSCs with the interdigitated electrodes in plane. The device area (A_{Device}) refers to the total surface area of interdigitated electrodes and the space between them. It is equal to electrode width (W) multiplied by the length (L): A_{Device}=W×L=0.41 cm×1.85 cm=0.75 cm². The device volume (V_{Device}) is estimated as: V_{Device}=W×L×H, where H stands for the height of the hybrid material and can be measured from previous cross-sectional SEM images.

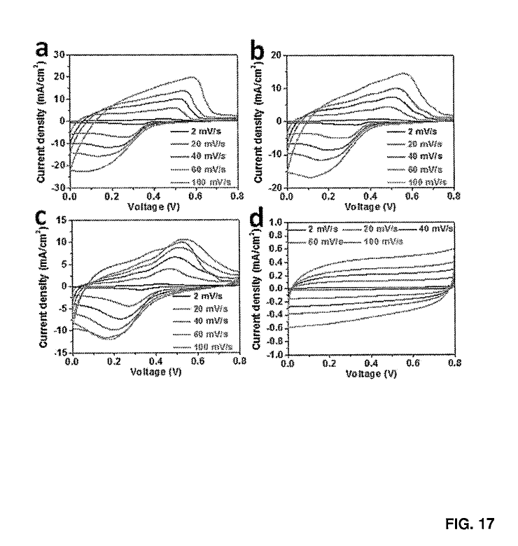

FIG. 17 provides cyclic voltammetry curves of LIG-PANI-15 (FIG. 17A), LIG-PANI-10 (FIG. 17B), LIG-PANI-5 (FIG. 17C), and LIG (FIG. 17D) over a scan rate range of 2 and 100 mV/s in the potential window from 0 to 0.8 V. FIG. 12D shows the CV curves of LIG-PANI-Y samples and LIG at a scan rate of 10 mV/s. Similar to LIG-MnO₂, the CV curve of LIG is minuscule compared to the others, indicating little contribution from the EDLC of LIG in the composite to the total capacitance. For LIG-PANI-15, LIG-PANI-10, and LIG-PANI-5, there were two pairs of redox peaks in the CV curves. The peaks from ˜0.35 V to ˜0.23 V result from the redox transition of PANI between leucoemeraldine and emeraldine states, and the peaks from ˜0.47 V to ˜0.30 V are caused by the transition between emeraldine and pernigraniline states. LIG-PANI-15 has the highest value in the CV curve area, demonstrating that it has the highest areal energy storage ability among all tested samples.

FIG. 17 shows CV curves of these samples at a scan rate ranging from 2 to 100 mV/s with an increased current, similar to that of LIG-MnO₂. When compared to LIG-PANI, the galvanostatic charge-discharge curve of LIG alone is negligible, further demonstrating little contribution in capacitance from LIG in the composite of LIG-PANI (FIG. 12D).

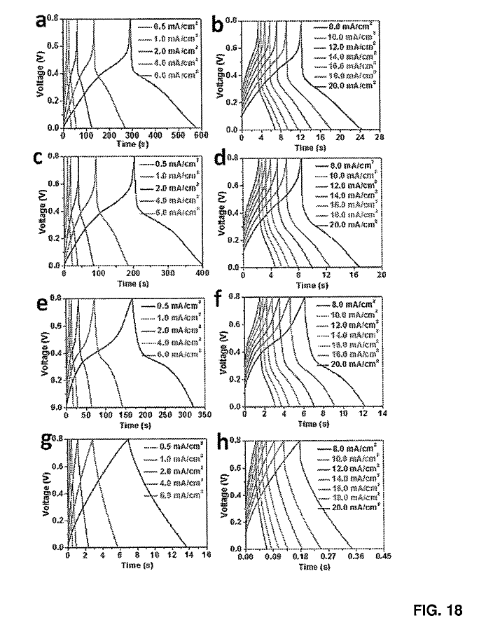

FIG. 18 shows galvanostatic charge discharge curves of LIG-PANI-15 (FIGS. 18A-B), LIG-PANI-10 (FIGS. 18C-D), LIG-PANI-5 (FIGS. 18E-F), and LIG (FIGS. 18G-H) over a current density range of 0.5 to 20.0 mA/cm² in the potential window from 0 to 0.8 V. FIG. 19 shows the volumetric specific capacitance of LIG-PANI-15, LIG-PANI-10, LIG-PANI-5, and LIG over a current density range of 0.5 and 20.0 mA/cm².

FIG. 20 shows the assembling of multiple devices in parallel and series configurations. FIG. 20A shows the digital image of three fabricated devices on a single PI sheet. FIG. 20B shows three single devices in parallel and series wiring schemes, respectively. FIG. 20C shows galvanostatic charge discharge curves of LIG-MnO₂-2.5 h in single and parallel at a current density of 2.0 mA/cm² and comparison with a single device. FIG. 20D shows galvanostatic charge discharge curves of LIG-MnO₂-2.5 h in single and series at a current density of 2.0 mA/cm². FIG. 20E shows galvanostatic charge discharge curves of LIG-PANI-15 in single and parallel device at a current density of 2.0 mA/cm². FIG. 20F shows galvanostatic charge discharge curves of LIG-PANI-15 in single and series at a current density of 2.0 mA/cm².

FIG. 21 shows cyclic voltammetry curves of LIG (FIG. 21A), LIG-FeOOH-1.0 h (FIG. 21B), LIG-FeOOH-1.5 h (FIG. 21C), and LIG-FeOOH-2.0 h (FIG. 21D) over a scan rate range of 10 and 100 mV/s in the potential window from 0 to −0.8 V (vs Ag/AgCl). In particular, FIG. 21 shows the CV curves of LIG and LIG-FeOOH—X at different scan rates of 10 to 100 mV/s in the potential window of 0 to −0.8 V (vs Ag/AgCl). The CV shapes of LIG demonstrate that LIG induces the decomposition of water at high negative voltages, as shown in FIG. 21A. The rectangular CV curves of LIG-FeOOH—X at different scan rate demonstrate the good capacitive behaviors.

LIG-FeOOH—X functions as negative electrodes in the asymmetric MSCs. The electrochemical performance of LIG-FeOOH—X are studied in the three-electrode system, in which LIG-FeOOH—X works as a working electrode, Pt foil works as a counter electrode, and Ag/AgCl works was a reference electrode in 5 M LiCl.

FIG. 22 shows galvanostatic charge discharge curves of LIG (FIG. 22A), LIG-FeOOH-1.0 h (FIG. 22B), LIG-FeOOH-1.5 h (FIG. 22C), LIG-FeOOH-2.0 h (FIG. 22D) over a current density range of 0.5 to 10 mA/cm² in the potential window from 0 to ˜0.8 V (vs Ag/AgCl). FIG. 22E shows the areal specific capacitance of LIG, LIG-FeOOH-1.0 h, LIG-FeOOH-1.5 h, and LIG-FeOOH-2.0 h over a current density range of 0.5 and 10 mA/cm². The curve from LIG is consistent with the CV analysis as shown in FIG. 22A.

FIGS. 22B-D show the galvanostatic charge-discharge curves of LIG-FeOOH—X at varying current densities. The nearly symmetrical charging and discharging curves and small voltage drops at initial discharge states indicate good capacitive behavior and high conductivity within the electrode. Based on these curves, the areal specific electrode capacitance of these samples are calculated as shown in FIG. 22E (C_{negative}=4I/(A_{negative}×(dV/dt)), where I is the current applied, A_{negative} is the total area of the electrode, and dV/dt is the slope of the discharge curve). LIG-FeOOH-1.5 h has the highest specific capacitance of 106 mF/cm² at 0.5 mA/cm² and decreases to 60 mF/ cm² when the current density increases to 10 mA/cm².

The loading amount of negative and positive electrodes in the asymmetric MSCs should be balanced in order to obtain the best cell performance. Therefore, the charges on the negative electrode (Q⁻) should be equal to the charges on the positive electrode (Q⁺). The charge stored at the negative electrode is determined by: Q⁻=C_{negative}×A_{negative}×V_{negative}×H_{negative}, where C_{negative} is the specific capacitance of the negative electrode, V_{negative} is the applied voltage, A_{negative} is the area value of the negative electrode, and H_{negative} is the height of the negative electrode.

The charge stored at the positive electrode is determined by: Q⁺=Cₚₒₛᵢₜᵢᵥₑ×Aₚₒₛᵢₜᵢᵥₑ×Vₚₒₛᵢₜᵢᵥₑ×Hₚₒₛᵢₜᵢᵥₑ, where Cₚₒₛᵢₜᵢᵥₑ is the specific capacitance of the positive electrode, Vₚₒₛᵢₜᵢᵥₑ is the applied voltage, Aₚₒₛᵢₜᵢᵥₑ is the area value of the positive electrode, and Hₚₒₛᵢₜᵢᵥₑ is the height of the positive electrode. In this asymmetric MSCs, LIG-MnO₂—X work as positive electrodes. LIG-MnO₂-1.0 h showed high charge amount compared to LIG-FeOOH—X. Therefore, Applicants reduced the deposition time in order to match that of the negative electrodes.

FIG. 23 shows the cross-sectional SEM image of LIG-MnO₂-0.27 h, showing the height of ˜40 μm. The scale bar is 100 μm. FIG. 24 shows cyclic voltammetry curves of LIG (FIG. 24A), LIG-MnO₂-0.14 h (FIG. 24B), LIG-MnO₂-0.27 h (FIG. 24C), LIG-MnO₂-0.56 h (FIG. 24D), and LIG-MnO₂-0.83 h (FIG. 24E) over a scan rate range of 10 and 100 mV/s in the potential window from 0 to 1.0 V (vs Ag/AgCl).

As shown in FIG. 24, LIG-MnO₂—X works as positive electrodes in the asymmetric MSCs. The electrochemical performance of LIG-MnO₂—X are also studied in the same three-electrode system. The curve from LIG alone is nearly negligible, again demonstrating little contribution in capacitance from LIG in the composite of LIG-MnO₂—X, which is consistent with the CV analysis in two-electrode system shown in FIG. 12B. The rectangular CV curves of LIG-MnO₂—X at different scan rates demonstrate the good capacitive behaviors.

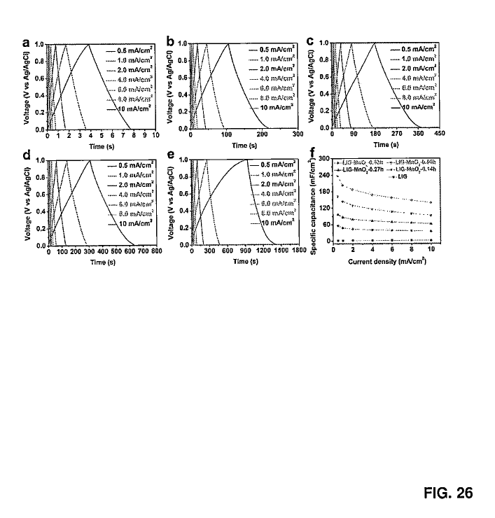

FIG. 26 shows the galvanostatic charge-discharge curves of LIG and LIG-MnO₂—X at a current density of 0.5 mA/cm² to 10 mA/cm². The curve from LIG is consistent with the CV analysis, as shown in FIG. 24A.

FIGS. 26B-E show the galvanostatic charge-discharge curves of LIG-MnO₂—X at varying current densities. All these samples show the almost symmetrical charging and discharging curves and small voltage drops at initial discharge states, indicating the good capacitive behavior and high conductivity. Based on these curves, the areal specific electrode capacitance of these samples are plotted as shown in FIG. 26F (Cₚₒₛᵢₜᵢᵥₑ=4I/(Aₚₒₛᵢₜᵢᵥₑ×(dV/dt)), where I is the current applied, Aₚₒₛᵢₜᵢᵥₑ is the total area of the electrode, and dV/dt is the slope of the discharge curve).

The specific capacitance of LIG-MnO₂—X increases with the increase of the MnO₂ amount in the LIG-MnO₂—X. LIG-MnO₂-0.27 h well-matches LIG-FeOOH-1.5 h in the amount charge. Therefore, they were chosen as positive and negative electrodes assembling the asymmetric MSCs, defined as LIG-FeOOH//LIG-MnO₂. FIG. 27 shows a digital image of one LED (1.7 V, 30 mA) lit by one asymmetric MSC of LIG-FeOOH//LIG-MnO₂.

FIG. 28 shows galvanostatic charge discharge curves of LIG-FeOOH//LIG-MnO₂ over a current density range of 5.0 to 10 mA/cm² in the potential window of 0 to 1.8 V. FIG. 31 shows Ragone plots of LIG-MnO₂, LIG-PANI, and LIG-FeOOH//LIG-MnO₂. Volumetric energy and power density of LIG-MnO₂ (FIG. 31A) and LIG-PANI (FIG. 31B) with different MnO₂ and PANI deposition amounts are compared with commercially available energy storage devices. Areal energy and power density of LIG-MnO₂ (FIG. 31C), LIG-PANI (FIG. 31D), and LIG-FeOOH//LIG-MnO₂ (FIG. 31E) with different MnO₂ and PANI deposition amounts are also shown.

FIG. 32 provides a comparison of the volumetric energy densities (FIG. 32A) and areal capacitance (FIG. 32B) of LIG-derived MSCs. Data of LIG-MSCs in aqueous acid electrolyte, LIG-MSCs in PVA/H⁺ electrolyte, and boron doped LIG-MSCs (B-LIG) in PVA/H⁺ electrolytes were from the literature.

Without further elaboration, it is believed that one skilled in the art can, using the description herein, utilize the present disclosure to its fullest extent. The embodiments described herein are to be construed as illustrative and not as constraining the remainder of the disclosure in any way whatsoever. While the embodiments have been shown and described, many variations and modifications thereof can be made by one skilled in the art without departing from the spirit and teachings of the invention. Accordingly, the scope of protection is not limited by the description set out above, but is only limited by the claims, including all equivalents of the subject matter of the claims. The disclosures of all patents, patent applications and publications cited herein are hereby incorporated herein by reference, to the extent that they provide procedural or other details consistent with and supplementary to those set forth herein.

What is claimed is:

1. A method of producing a graphene hybrid material, said method comprising:
exposing a graphene precursor material to a laser source to form a laser-induced graphene, wherein the laser-induced graphene is derived from the graphene precursor material; and
associating a pseudocapacitive material with the laser-induced graphene.

2. The method of claim 1, wherein the graphene precursor material comprises a polymer.

3. The method of claim 2, wherein the polymer is selected from the group consisting of polymer films, polymer monoliths, polymer powders, polymer blocks, optically transparent polymers, homopolymers, vinyl polymers, block co-polymers, carbonized polymers, aromatic polymers, cyclic polymers, doped polymers, polyimide (PI), polyetherimide (PEI), polyether ether ketone (PEEK), and combinations thereof.

4. The method of claim 1, wherein the graphene precursor material is in the form of at least one of sheets, films, thin films, pellets, powders, coupons, blocks, monolithic blocks, composites, fabricated parts, electronic circuit substrates, flexible substrates, rigid substrates, and combinations thereof.

5. The method claim 1, wherein the graphene precursor material comprises a polymer film.

6. The method of claim 1, wherein the graphene precursor material is chosen such that an absorbance band in the graphene precursor material matches the excitation wavelength of the laser source.

7. The method of claim 1, wherein the laser source is selected from the group consisting of a solid state laser source, a gas phase laser source, an infrared laser source, a CO₂ laser source, a UV laser source, a visible laser source, a fiber laser source, and combinations thereof.

8. The method of claim 1, wherein the laser source is a CO₂ laser source.

9. The method of claim 1, wherein the exposing comprises tuning one or more parameters of the laser source.

10. The method of claim 9, wherein the one or more parameters of the laser source are selected from the group consisting of laser wavelength, laser power, laser energy density, laser pulse width, gas environment, gas pressure, gas flow rate, and combinations thereof.

11. The method of claim 10, wherein a wavelength of the laser source is tuned to match an absorbance band of the graphene precursor material.

12. The method of claim 1, wherein the exposing comprises exposing a surface of the graphene precursor material to a laser source, wherein the exposing results in formation of the laser-induced graphene on the surface of the graphene precursor material.

13. The method of claim 12, wherein the exposing comprises patterning the surface of the graphene precursor material with the laser-induced graphene.

14. The method of claim 12, wherein the patterning results in the formation of an interdigitated structure on the surface of the graphene precursor material.

15. The method of claim 1, wherein the laser-induced graphene is embedded with the graphene precursor material.

16. The method of claim 1, wherein the exposing results in conversion of the entire graphene precursor material to laser-induced graphene.

17. The method of claim 1, wherein the laser-induced graphene is separated from the graphene precursor material.

18. The method of claim 17, wherein the exposing results in the separation of the formed laser-induced graphene from the remaining graphene precursor material.

19. The method of claim 17, further comprising a step of separating the formed laser-induced graphene from the graphene precursor material.

20. The method of claim 1, wherein the laser-induced graphene is selected from the group consisting of single-layered graphene, multi-layered graphene, double-layered graphene, triple-layered graphene, doped graphene, porous graphene, unfunctionalized graphene, pristine graphene, functionalized graphene, oxidized graphene, turbostratic graphene, graphene coated with metal nanoparticles, graphene metal carbides, graphene metal oxides, graphene films, graphene powders, porous graphene powders, porous graphene films, graphite, and combinations thereof.

21. The method of claim 1, wherein the laser-induced graphene comprises a porous graphene.

22. The method of claim 1, wherein the laser-induced graphene has a surface area ranging from about 100 m²/g to about 3,000 m²/g.

23. The method of claim 1, wherein the laser-induced graphene has a thickness ranging from about 0.3 nm to about 1 cm.

24. The method of claim 1, wherein the laser-induced graphene comprises a polycrystalline lattice.

25. The method of claim 24, wherein the polycrystalline lattice comprises ring structures selected from the group consisting of hexagons, heptagons, pentagons, and combinations thereof.

26. The method of claim 1, wherein the pseudocapacitive material is selected from the group consisting of polymers, conducting polymers, metals, metal oxides, metal chalcogenides, metal salts, metal carbides, transition metals, transition metal oxides, transition metal chalcogenides, transition metal salts, transition metal carbides, heteroatoms, organic additives, inorganic additives, metal organic compounds, and combinations thereof.

27. The method of claim 1, wherein the pseudocapacitive material comprises a conducting polymer.

28. The method of claim 27, wherein the conducting polymer is selected from the group consisting of polyaniline, polythiophene, polypyrrole, polyacetylene, and combinations thereof.

29. The method of claim 27, wherein the conducting polymer comprises polyaniline.

30. The method of claim 1, wherein the pseudocapacitive material comprises a metal oxide.

31. The method of claim 30, wherein the metal oxide is selected from the group consisting of iron oxide, magnesium oxide, copper oxide, cobalt oxide, nickel oxide, ruthenium oxide, magnetite, ferric oxyhydroxide, manganese dioxide, titanium oxide, vanadium oxide, platinum oxide, palladium oxide, and combinations thereof.

32. The method of claim 30, wherein the metal oxide comprises ferric oxyhydroxide.

33. The method of claim 30, wherein the metal oxide comprises manganese dioxide.

34. The method of claim 1, wherein the associating occurs before the formation of the laser-induced graphene.

35. The method of claim 1, wherein the associating occurs during the formation of the laser-induced graphene.

36. The method of claim 1, wherein the associating occurs after the formation of the laser-induced graphene.

37. The method of claim 1, wherein the associating occurs by a method selected from the group consisting of electrochemical deposition, coating, spin coating, spraying, spray coating, patterning, thermal activation, and combinations thereof.

38. The method of claim 1, wherein the associating comprises electrochemical deposition.

39. The method of claim 38, wherein the electrochemical deposition occurs by a method selected from the group consisting of cyclic voltammetry, linear sweep voltammetry, chronopotentiometry, chronoamperometry, chronocoulometry, and combinations thereof.

40. The method of claim 1, wherein the associating occurs on a single side of the laser-induced graphene.

41. The method of claim 1, wherein the associating occurs on opposite sides of the laser-induced graphene.

42. The method of claim 1, wherein the associating results in a partial coverage of the laser-induced graphene with the pseudocapacitive material.

43. The method of claim 1, wherein the associating results in a complete coverage of the laser-induced graphene with the pseudocapacitive material.

44. The method of claim 1, wherein the graphene hybrid material has a thickness ranging from about 1 μm to about 500 μm.

45. The method of claim 1, wherein the graphene hybrid material has a thickness ranging from about 10 μm to about 200 μm.

46. The method of claim 1, wherein the graphene hybrid material has a thickness ranging from about 30 μm to about 100 μm.

47. The method of claim 1, wherein the graphene hybrid material is embedded with the graphene precursor material.

48. The method of claim 1, wherein the graphene hybrid material is separated from the graphene precursor material.

49. The method of claim 48, further comprising a step of separating the graphene hybrid material from the graphene precursor material.

50. The method of claim 1, further comprising a step of utilizing the graphene hybrid material as a component of an electronic device.

51. The method of claim 50, wherein the graphene hybrid material is utilized as a component of the electronic device while embedded with the graphene precursor material.

52. The method of claim 50, wherein the graphene hybrid material is utilized as a component of the electronic device after separation from the graphene precursor material.

53. The method of claim 50, wherein the electronic device is an energy storage device or an energy generation device.

54. The method of claim 50, wherein the electronic device is an energy storage device.

55. The method of claim 50, wherein the electronic device is selected from the group consisting of capacitors, super capacitors, micro supercapacitors, pseudo capacitors, batteries, micro batteries, lithium-ion batteries, sodium-ion batteries, magnesium-ion batteries, electrodes, conductive electrodes, sensors, photovoltaic devices, electronic circuits, fuel cell devices, thermal management devices, biomedical devices, transistors, water splitting devices, and combinations thereof.

56. The method of claim 50, wherein the electronic device is a microsupercapacitor.

57. The method of claim 50, wherein the graphene hybrid material is utilized in the electronic device as at least one of electrodes, current collectors, additives, active materials, and combinations thereof.

58. The method of claim 50, wherein the graphene hybrid material is utilized as an electrode in the electronic device.

59. The method of claim 58, wherein the electrode is selected from the group consisting of positive electrodes, negative electrodes, electrochemical double layer capacitance (EDLC) electrodes, and combinations thereof.

60. The method of claim 50, wherein the electronic device has an areal capacitance ranging from about 100 mF/cm² to about 10 F/cm² at a current density of 0.5 mA/cm².

61. The method of claim 50, wherein the electronic device has an areal energy density ranging from about 1 μWb/cm²to about 400 μWh/cm² at a current density of 0.5 mA/cm².

62. The method of claim 50, wherein the electronic device has an areal power density ranging from about 100 μW/cm² to about 100 mW/cm².

63. The method of claim 50, wherein the electronic device retains at least 90% of its original capacitance value after more than 10,000 cycles.

64. A graphene hybrid material comprising:
a laser-induced graphene derived from a graphene precursor material, wherein the graphene is associated with a pseudocapacitive material.

65. The graphene hybrid material of claim 64, wherein the laser-induced graphene is selected from the group consisting of single-layered graphene, multi-layered graphene, double-layered graphene, triple-layered graphene, doped graphene, porous graphene, unfunctionalized graphene, pristine graphene, functionalized graphene, oxidized graphene, turbostratic graphene, graphene coated with metal nanoparticles, graphene metal carbides, graphene metal oxides, graphene films, graphene powders, porous graphene powders, porous graphene films, graphite, and combinations thereof.

66. The graphene hybrid material of claim 64, wherein the laser-induced graphene comprises a porous graphene.

67. The graphene hybrid material of claim 64, wherein the laser-induced graphene has a surface area ranging from about 100 m²/g to about 3,000 m²/g.

68. The graphene hybrid material of claim 64, wherein the laser-induced graphene has a thickness ranging from about 0.3 nm to about 1 cm.

69. The graphene hybrid material of claim 64, wherein the laser-induced graphene comprises a polycrystalline lattice.

70. The graphene hybrid material of claim 64, wherein the pseudocapacitive material is selected from the group consisting of polymers, conducting polymers, metals, metal oxides, metal chalcogenides, metal salts, metal carbides, transition metals, transition metal oxides, transition metal chalcogenides, transition metal salts, transition metal carbides, heteroatoms, organic additives, inorganic additives, metal organic compounds, and combinations thereof.

71. The graphene hybrid material of claim 64, wherein the pseudocapacitive material comprises a conducting polymer.

72. The graphene hybrid material of claim 71, wherein the conducting polymer is selected from the group consisting of polyaniline, polythiophene, polypyrrole, polyacetylene, and combinations thereof.

73. The graphene hybrid material of claim 71, wherein the conducting polymer comprises polyaniline.

74. The graphene hybrid material of claim 64, wherein the pseudocapacitive material comprises a metal oxide.

75. The graphene hybrid material of claim 74, wherein the metal oxide is selected from the group consisting of iron oxide, magnesium oxide, copper oxide, cobalt oxide, nickel oxide, ruthenium oxide, magnetite, ferric oxyhydroxide, manganese dioxide, titanium oxide, vanadium oxide, platinum oxide, palladium oxide, and combinations thereof.

76. The graphene hybrid material of claim 74, wherein the metal oxide comprises ferric oxyhydroxide.

77. The graphene hybrid material of claim 74, wherein the metal oxide comprises manganese dioxide.

78. The graphene hybrid material of claim 64, wherein the pseudocapacitive material partially covers the laser-induced graphene.

79. The graphene hybrid material of claim 64, wherein the pseudocapacitive material fully covers the laser-induced graphene.

80. The graphene hybrid material of claim 64, wherein the graphene hybrid material has a thickness ranging from about 1 μm to about 500 μm.

81. The graphene hybrid material of claim 64, wherein the graphene is on a surface of the graphene precursor material.

82. The graphene hybrid material of claim 64, wherein the graphene is embedded with the graphene precursor material.

83. The graphene hybrid material of claim 64, wherein the graphene is separated from the graphene precursor material.

84. The graphene hybrid material of claim 64, wherein the graphene precursor material comprises a polymer.

85. The graphene hybrid material of claim 84, wherein the polymer is selected from the group consisting of polymer films, polymer monoliths, polymer powders, polymer blocks, optically transparent polymers, homopolymers, vinyl polymers, block co-polymers, carbonized polymers, aromatic polymers, cyclic polymers, doped polymers, polyimide (PI), polyetherimide (PEI), polyether ether ketone (PEEK), and combinations thereof.

86. The graphene hybrid material of claim 64, wherein the graphene precursor material comprises a polymer film.

87. The graphene hybrid material of claim 64, wherein the graphene hybrid material is utilized as a component of an electronic device.

88. The graphene hybrid material of claim 87, wherein the graphene hybrid material is utilized as a component of the electronic device while embedded with the graphene precursor material.

89. The graphene hybrid material of claim 87, wherein the graphene hybrid material is utilized as a component of the electronic device after separation from the graphene precursor material.

90. The graphene hybrid material of claim 87, wherein the electronic device is an energy storage device or an energy generation device.

91. The graphene hybrid material of claim 87, wherein the electronic device is an energy storage device.

92. The graphene hybrid material of claim 87, wherein the electronic device is selected from the group consisting of capacitors, super capacitors, micro supercapacitors, pseudo capacitors, batteries, micro batteries, lithium-ion batteries, sodium-ion batteries, magnesium-ion batteries, electrodes, conductive electrodes, sensors, photovoltaic devices, electronic circuits, fuel cell devices, thermal management devices, biomedical devices, transistors, water splitting devices, and combinations thereof.

93. The graphene hybrid material of claim 87, wherein the electronic device is a microsupercapacitor.

94. The graphene hybrid material of claim 87, wherein the graphene hybrid material is utilized in the electronic device as at least one of electrodes, current collectors, additives, active materials, and combinations thereof.

95. The graphene hybrid material of claim 87, wherein the graphene hybrid material is utilized as an electrode in the electronic device.

96. The graphene hybrid material of claim 87, wherein the electronic device has an areal capacitance ranging from about 100 mF/cm² to about 10 F/cm² at a current density of 0.5 mA/cm².

97. The graphene hybrid material of claim 87, wherein the electronic device has an areal energy density ranging from about 1 μWh/cm² to about 400 μWh/cm² at a current density of 0.5 mA/cm².

98. The graphene hybrid material of claim 87, wherein the electronic device has an areal power density ranging from about 100 μW/cm² to about 100 mW/cm².

99. The graphene hybrid material of claim 87, wherein the electronic device retains at least 90% of its original capacitance value after more than 10,000 cycles.
